(19) United States
(12) Patent Application Publication
(10) Pub. No.: US 2023/0298015 A1
(43) Pub. Date: Sep. 21, 2023

(54) SYSTEMS AND METHODS FOR VERIFICATION OF PROTECTED PRIVATE INFORMATION

(71) Applicant: ANKR PBC, San Francisco, CA (US)

(72) Inventors: Mehmet Sabir Kiraz, Leicester (GB); Suleyman Kardas, Batman (TR); Liangnan Wu, Redwood City, CA (US)

(21) Appl. No.: 18/186,700

(22) Filed: Mar. 20, 2023

Related U.S. Application Data
(60) Provisional application No. 63/321,943, filed on Mar. 21, 2022.

(51) Int. Cl. G06Q 20/38; H04L 9/08; H04L 9/30; G06Q 20/40

(52) U.S. Cl. CPC G06Q 20/3829; H04L 9/0861; H04L 9/30; G06Q 20/401; G06Q 2220/00

(57) ABSTRACT

Systems and methods for validating information of a user by registering a user private identifier to a registry may generate a user public key and a user private key, the keys together forming a user cryptographic public/private key pair, generate generating a nonce value using a cryptographic random generator, generate the user public identifier, wherein the user public identifier is a hash value generated by applying a cryptographic hash function to: the user public key, the nonce value, and at least one identity trait that the user has previously registered with the registry, sign the user public identifier with the user private key to obtain a signed user public identifier, generate a zero knowledge proof of the at least one identity trait; and transmit to the registry computer system: the user public identifier, the signed user public identifier, the user public key, and the zero knowledge proof.

### CROSS REFERENCE FOR RELATED APPLICATIONS

This application claims the benefit under 35 U.S.C. § 119(e) of the earlier filing date of U.S. Provisional Patent Application No. 63/321,943 filed on Mar. 21, 2022, the disclosures of which are incorporated by reference herein.

### FIELD

This disclosure relates to processor provided applications provided via a network.

### BACKGROUND

Network applications provide services via communications across a decentralized network, e.g., the Internet, local networks, wireless networks, and mobile networks. Positive identification of a participant in networked applications is often desirable. Known solutions require that a user transmit personally identifying information that is verified against a database containing stored copies of such information. New innovations in decentralized immutable databases allow for a user to conduct transactions anonymously.

### BRIEF DESCRIPTION OF THE DRAWINGS

Various exemplary embodiments in accordance with this disclosure are disclosed herein with reference to the following figures:

FIG. 1 illustrates an exemplary network environment in accordance with this disclosure.

FIG. 2 illustrates an exemplary flow diagram in accordance with this disclosure.

FIG. 3 illustrates various aspects in accordance with this disclosure.

FIG. 4 illustrates various aspects in accordance with this disclosure.

FIG. 5 illustrates various aspects of a distributed ledger in accordance with this disclosure.

FIG. 6 illustrates various aspects of a distributed ledger in accordance with this disclosure.

FIG. 7 illustrates various aspects in accordance with this disclosure.

FIG. 8 illustrates various aspects in accordance with this disclosure.

FIG. 9 illustrates various aspects in accordance with this disclosure.

FIG. 10 illustrates embodiments of a computer system within a network environment in accordance with this disclosure.

FIG. 11 illustrates various steps in accordance with this disclosure.

FIG. 12 illustrates various steps in accordance with this disclosure.

FIG. 13 illustrates various steps in accordance with this disclosure.

FIG. 14 illustrates various steps in accordance with this disclosure.

FIG. 15 illustrates various steps in accordance with this disclosure.

### DETAILED DESCRIPTION

Network applications suffer from a variety of draw backs that are identified herein below. Many of these drawbacks can be suitably addressed by implementing an immutable and anonymous public, private, or hybrid type databases for storing records, e.g., records of identity trait information, e.g., personal identifying information, financial information, medical records, etc. Recent developments in blockchain technology have enabled immutable data stores, e.g., blockchain based public ledgers. Many such blockchain based public ledgers operate on a principle of anonymity. In many applications this is a desirable feature. However, it is now recognized that it is desirable to provide a pseudo-anonymous system for conducting transactions with network applications in which various transactions among participates are conducted anonymously while selectively revealing only required units of information between participants, and while also providing a mechanism to allow for auditing and traceability of transactions by an authorized entity, e.g., a government authority. Privacy of the user is ensured outside of such auditing mechanisms, because sufficient information to identify transactions is not maintained by any single entity.

Network applications and network resources in combination with network connected devices may be configured and interconnected using publicly available communications and computing standards, public and proprietary APIs, and open source of proprietary software in order to provide special purpose computing tools and customized user experiences. These tools and experiences extend from online banking, shopping, gambling, to facilitating collaboration in research, to participating in social communities online both public and private.

Network applications and resources and network connected devices are, however, extremely susceptible to nefarious conduct that is, in part, a result of the open source and publicly available technologies that underlie open networks like the Internet as well as the anonymity provided to network users of such open network.

In many applications, it is necessary for a service to positively and reliably identify a user or information about a user. This identification may be necessary to associate a user with a collection of stored information or to associate a user with specific features of the service to which they are authorized to access or participate in. For a few examples, a service identifies a user of an online community and associates that user with certain profile information and social channels; a service identifies a user of a bank service and associates that user with certain bank accounts and bank services; a service identifies a user of a decentralized digital currency exchange (DEX), for example a DEX built on the Uniswap Protocol, and associates that user with one or more records stored in one or more blockchain based data storage facilities, e.g., a blockchain database provided in a distributed network. In each case, it is typical that a user provides some form of identification that allows a network application to positively identify the user. Such identification may be in the form of biometric information, a username and password combination, various forms of two-factor authentication, an ID number, a digital wallet, or a token, but it will be appreciated on a full reading of this disclosure that identifying information utilized in user identification and authentication in network applications may take many forms. As used herein, the term network application is meant to describe any collection of network resources and software that operate together to effect a goal. For example, a network application may be a website provided by an online seller, an online auction house, an online bank, or an online social community. A network application may also refer to a blockchain network, including the various computers networks and software that work together to provide, maintain, and update a public ledger. A network application may further refer to a website service that reads and writes to a blockchain.

We have identified drawbacks in known user identification techniques employed by known network applications. In centralized network applications having an authority service, user information is typically stored in a centralized manner, e.g., in the form of a digital account or a digital profile. When a nefarious actor operating anonymously and remotely over a network, or internally, is able to gain access to that centralized repository (a regular occurrence even in highly secure finance and government networks and applications), that stored centralized data is at risk of being compromised. In many known cases, valuable data has in fact been stolen from centralized data stores maintained by, e.g., banks, telephone mobile, ISPs, government databases, social networks, finance providers, credit provider facilities, and other network application service providers. Furthermore, such nefarious actors are also able to intercept network traffic in transit further putting valuable information at risk when is unnecessarily transmitted across networks.

Recently developed network applications operate within a paradigm colloquially referred to as self-sovereign and borderless. Typical borderless and self-sovereign applications are driven by or interact with a blockchain application, such as a digital ledger application or a blockchain network. These applications are considered borderless, because membership typically requires only an application, e.g., a digital wallet, with access to such a blockchain based network application. These are self-sovereign, because they rely on no centralized authority to enforce rules or to create or verify identity instruments, e.g., instruments like a magnetically encoded ID card issued by a government entity or by a finance institution, a social security card, a credit card, a utility bill.

Often, self-sovereign and borderless applications rely on and shield a user's anonymity. In many cases, this is considered a desirable feature of the application. However, as such applications have matured and grown, most governments, financial institutions, and potential investors in such technology have come to desire an ability to verify a user's identity or particular identity traits (i.e., a set of one or more unique traits associated with an individual or entity, e.g., ID card information, credit card information certificates, passwords, emails, SIM cards, biometric identifiers) when necessary. This is especially true in certain financial applications, like a DEX, where true anonymity raises concerns of illegal conduct such as money laundering or other illicit transactions. Also, in view of emerging and current government regulations, e.g., GDPR, regarding the disclosure of a user's personally identifying information or other attributes (collectively identity traits), it is desirable to provide a technological solution for selective disclosure of identity traits between or within network applications that complies with government or institutional rules and regulations.

In the context of network applications, verification processes (referred to herein as Know Your Customer (KYC) processes) are employed to identify a user in order to, e.g., perform a credibility check on the user or perform a risk a management analysis on the user, or for any technological application where a user's authenticity or credibility is a pre-requisite. Typical solutions generally require an authority process that verifies an individual or other entity by referencing a data store containing a collection of user specific identity traits about a plurality of users. These solutions are expensive, because they require an authority for each application, where such authorities are necessarily overhead and because they require that each authority maintain up-to-date records of its users' identity traits. These solutions also creates many copies of users' identity trait information in many disparate data stores resulting in many single points of exposure of large amounts of valuable user information. This is because each application maintains its own copies of user information for authentication and verification purposes, and because user information is regularly transmitted between participants. However, there exist no decentralized alternative to maintaining such information in a secure decentralized yet network accessible and auditable means. For example, typical decentralized exchanges (DEXes) currently operate based on privacy and anonymity and cannot satisfy KYC requirements in order to meet legal requirements or to meet the ever increasing demand that service providers sufficiently know their customers.

This disclosure is directed to systems, devices, methods, media, and techniques for selective and secure disclosure of identity traits to decentralized network applications. Embodiments in accordance with this disclosure are necessarily technological improvements, because decentralized network applications themselves are technological systems facilitated by software and distributed networks comprising distributed computer processors executing such software. Various embodiments herein that interact with or refer to information stored in blockchain based databases are also necessarily technological solutions, because blockchain based databases are necessarily technological in nature and exist only within the realm of computer networks. While new, blockchain datastores remain cutting edge technology and are not routinely employed in modern business and finance applications due to their technological limitations—namely their susceptibility to use that facilitates and furthers unlawful or illicit conduct.

In embodiments, a blockchain based system and related processes provide decentralized KYC technological functions as a service to decentralized applications. In traditional KYC scenarios, a user bearing an identity instrument, like a passport, credit card, driver's license, bank book, bearer bonds, medical records, a utility bill, or the like, physically delivers the identity instrument to a service provider, e.g., a bank or credit provider, medical provider, private company, or the like in order to prove their identity. Developments in computer technology have allowed users to electronically identify themselves to application providers with credentials issued by an authority, but application providers traditionally maintain a centralized data store containing a user's personally identifying information and/or other identity traits which is expensive and insecure. In preferred embodiments a blockchain based network application increases the efficiency over traditional and previously known KYC technologies, and does so with reduced risk, minimal onboard time, less overall costs, while allowing for auditing and user identification by governing entity, e.g., law enforcement or tax authorities.

The problems identified above are address by embodiments in accordance with this disclosure as described below in reference to drawings of exemplary embodiments.

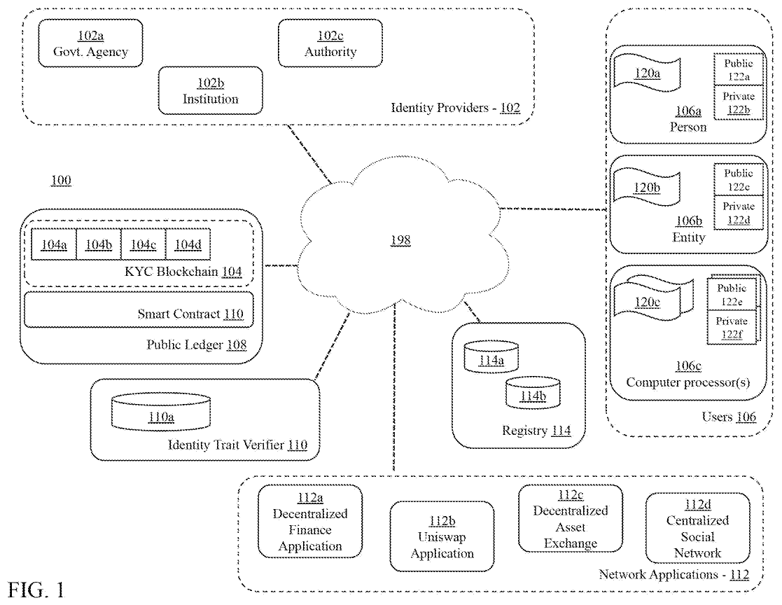

FIG. 1 illustrates various aspects of a decentralized network application environment 100 in accordance with this disclosure. A user 106 may be a person 106a, an entity 106b like a business or a trust, or an entity may be a computer 106c acting by its own volition or on behalf of its owner. In each case a user is modelled for interacting with a network application within a network application environment 100 in a variety of ways, non-limiting examples of which are a username, a real name, a unique personal identifier, a passport number, an ID card, or any of various biometric data or as a hash generated based on various identity traits, or any combination of these or other similar identifying information, or identity traits. In embodiments, e.g., a user 106c may be represented by a hash created based on internal digital identifiers like a MAC address or a hard drive GUID or combinations thereof or other unique information that reliably identifies a user, e.g., 106c. A user may also be identified by a public/private key pair, e.g., 122a/122b, 122c/122d, 122e/122f. In various embodiments, a user self generates a public/private key pair, while in other various embodiments a public/private key pair is assigned to a user.

Various users 106 have an individualized set of identity traits, including one or more identity traits that are issued by and verifiable by identify providers 102. For example, a user 106a may be issued a government photo identification by a government agency 102a. A user, e.g., 106a, may physically deliver identity instruments provided by one or more identify providers 102 to a registry 114; also, e.g., a computer 106c may communicate via a network (not explicitly illustrated) with registry 114 and thereby transmit an identity instrument to a registry 114.

A registry 114 is a fully trusted network application based service that is publicly identifiable through a smart contract stored, e.g., on a blockchain. A registry is a single application that stores and updates a user's identity information, and is configured so that a user's data is never stored on a public ledger, e.g., 108, and configured so that a user's data is never transmitted to third parties, e.g., a network application 112, during an authentication process. Registry 114 maintains a collection of records reflecting a user's, e.g., 106b's, identity instruments which may include diligence records detailing steps taken by a registry to verify an identity instrument. For example, a registry may perform an electronic credit check via a network in communication with an authority 102c, e.g., a credit authority, or a registry 114 may verify an available balance with an institution 102b, e.g., a financial institution. A registry 114 may, e.g., verify a country of residence or a nation of origin based on a user's passport. Registry 114 may maintain such identity trait records in one or more a data stores, e.g., a database, file, or other data storage facility, 114a, or e.g., a blockchain database 114b. When a registry, e.g., 114, has sufficient confidence in the identity traits of the user, the registry will issue a user a one or more digital certificates, e.g., 120a, 120b, 120c. For example, when registry 114 verifies a user's, e.g., 106a's, government issued photo identification, registry 114 may generate a certificate 120a in accordance with this disclosure that confirms and attests to the validity of the identity traits embodied in the user's government issued photo (e.g., name, date of birth, issue date, address, unique identifier numbers or symbols, eye color, sex, and the like). A user may further register their public key, e.g., 122a, 122b, 122c, with a registry, e.g., 114, in such a way that only the registry to which a public key, e.g., 122a, 122b, 122c, is registered, e.g., 114, has knowledge of the association between the public key, 122a, 122b, 122c, and its registered user, e.g., 106a, 106b, 106c. Upon reading this entire disclosure, one will appreciate that devices and processes of privately registering a public key, e.g., 122a, with a registry, e.g., 114, are within their skill. Each certificate 120 is unique to a user but includes no explicit or discernable identity trait information; in other words a certificate is generated in a manner that preserves a user's privacy, but can be used, e.g., to authenticate a user to one or more third party network applications, e.g., 112, while keeping the user's relationship with any particular network application hidden.

Various users, e.g., 106a, 106b, 106c, may interact with one or more network applications 112, examples of which include without limitation decentralized finance applications 112a, Uniswap applications 112b, and decentralized asset exchanges 112c for exchanging exemplary assets like digital coins, digital information, or digital property instruments. One or more decentralized network applications, e.g., 112a, 112b, 112c, interact with one or more public ledgers, e.g., public ledger 108. In various embodiments, a user, e.g., 106a, may also interact with a centralized service, e.g., a centralized social network 112d having a single central authority that maintains and stores user information and enforces usage policies.

A public ledger 108 in various embodiments in accordance with this disclosure is a distributed public ledger 108 comprising a smart contract 110 and a blockchain 104 in which one or more transactions are recorded in blocks of a blockchain, e.g., blocks 104a, 104b, 104c, 104d. In some embodiments a blockchain 104 is a KYC blockchain that consists only of a signed hashes of user credentials and of revoked user credentials. One will appreciate that other information may also be stored as desired.

One will appreciate that each aspect of the decentralized network application environment 100 may be network reachable by each other aspect of environment 100 via a network 198, e.g., the Internet. But, it will also be appreciated that certain aspects are only reachable via private networks without departing from the scope of this disclosure. For example, an institution 102b, e.g., a finance institution, may issue a user 106a an account associated with an account ID and certain account information that the user may access with a username and password or other credentials. In other cases, aspects may only communicate via non-electronic means. For example, an authority 102c, e.g., a utility authority, may issue a user 106a a bill bearing an account number associated with an address and an account standing, or a credit authority may maintain a credit report about a business entity 106b.

In various embodiments, a verifier, e.g., identity trait verifier 110, provides a digital wallet service that communicates as necessary within network application environment 100 with users 106, e.g., 106a, 106b, 106c, network applications 112, e.g., 112a, 112b, 112c, 112d and one or more registries 114 in order to verify a set of selectively disclosed identity attributes in order to verify a user or a user's identity traits to one or more decentralized network applications and for realizing one or more transactions on one or more public ledgers 108. A verifier, e.g., 110, also generates a set of securely stored logs 110a as output of its processing of user verification tasks. The logs 110a are generated in a manner that maintains a user's privacy but with the exception that they may be interpreted by a registry, e.g., 114, which maintains sufficient information to allow the logs 110a to be converted to a human readable form (or other computer readable form) for auditing and law enforcement purposes. In some embodiments, a network application, e.g., 112c, in accordance with this disclosure is considered KYC complaint if and only if all of its users are eligible for the transaction that application performs and only a corresponding KYC registry, e.g., 114, has access to its user's identity trait information.

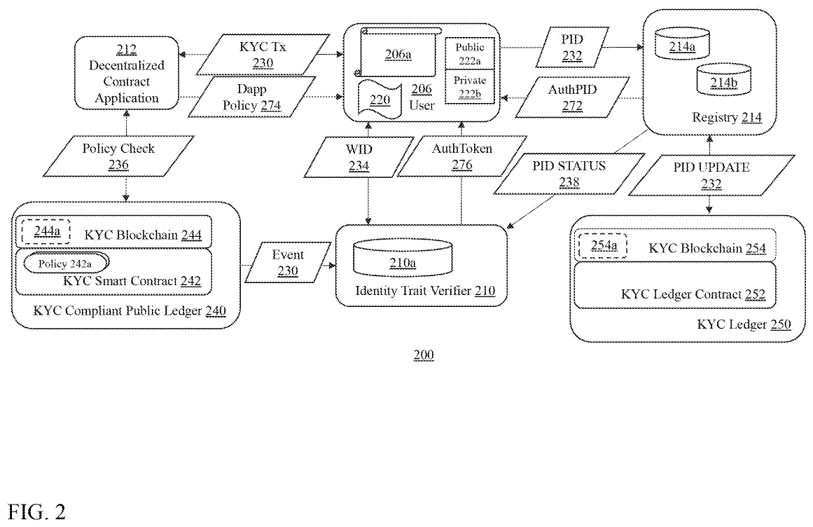

FIG. 2 illustrates of an exemplary flow of data between participants in various embodiments of a network application environment 200. A user 206 employees a digital wallet 206a to generate a KYC transaction (Tx) 230 on a decentralized application such as a decentralized contract application 212. A decentralized contract application 212 performs a policy check 236. In various exemplary embodiments a policy check 236 may involve querying a blockchain 244 based smart contract 242 on a public ledger 240 in order to determine whether a digital wallet 206a of a user 206 satisfies one or more policies 242a of the smart contract 242. Such policies may establish prerequisites that must be satisfied in order to participate with application 212. One will appreciate that these are all technological solutions, because blockchain based smart contracts, e.g., 242, and other decentralized applications, do not exist outside of computer networks. In embodiments, a digital wallet, e.g., 206a, is a software application stored in a memory that is executed on one or more processors in order to control access to digital assets, manage digital keys and digital addresses, to track digital asset balances as stored by various network application or as stored on various public ledgers (e.g., a blockchain based ledger), and to create and sign transactions, e.g., between a user and a network application. In all embodiments, a digital wallet cannot be replicated outside of computer processes, because interacting with a blockchain requires transmitting information stored within a digital wallet to a blockchain application via a computer network.

In embodiments a digital wallet, e.g., 206a, also serves as a data store or digital container object for storing and managing a user's, e.g., user 206's, keys and certificates. In some embodiments, a wallet never stores coins or other digital assets, but rather it stores keys which are used to sign transactions and/or access and to manage assets. A wallet stores one or more keys, which are digital signatures. Common digital signatures used in distributed, blockchain based, application spaces (e.g., public blockchain networks) include without limitation ECDSA, EdDSA, and BLS. A typical digital signature in accordance with this disclosure is a public and private key pair, e.g., 222a/222b. In a common application, a wallet, e.g., 206a, employs a public key, e.g., 222a, to receive funds while it employs a private key, e.g., 222b, to digitally sign transactions. To utilize assets, e.g., a collection of digital coins, a private key signature can be validated against a public key without revealing the private key. In our experiments we have found that using EdDSA algorithm for digital signatures performs slightly faster for curves like edwards25519 and edwards448, which may be used in applications in accordance with this disclosure, and unlike ECDSA it is not possible for EdDSA to recover the signer's public key from the signature and the message. One will appreciate that there are other suitable digital signature technologies that may be employed.

In this example, a user 206 is assumed to have already registered with a registry 214 and registry 214 maintains a record of user 206's identity traits and diligence records in its data stores 214a, 214b and a signed hash of a user credentials 254a is stored on a KYC blockchain 254. Such a registered user 206 may then generate a private identification number in accordance with this disclosure, or PID, 232 and transmits that PID 232 to a registry 214 for authentication (upon reading this full disclosure one will appreciate that a user's credentials and PID may be updated 232 from time to time). Having authenticated a user's 206 PID 232 a registry 214 generates an authorized PID and transmits the authorized PID 272 back to the user's 206's wallet 206a. This authorized PID 272 is incorporated into or part of a transaction 230 generated by a wallet 206a. When a smart contract validates an authorized PID 272, a record of the transaction is stored on a KYC Blockchain 244 in accordance with this disclosure. In some embodiments, a KYC registry may delete human readable copies of a user's identity information once that information is validated and only stores obfuscated representations of a user's information, e.g., by storing a hashed copy of a user's credentials, e.g., 254a. In various embodiments, an authorized PID, e.g., 272, is an example of a KYC registry certificate, e.g., 120a, and may be stored in a user's wallet together with other certificates, e.g., 220.

In order to execute a transaction 230 in a manner that protects a user's privacy against unnecessary disclosure, user 206 registers a wallet public key 234 with identity trait verifier 210 based on a user's authorized PID 272 and based on policy information, e.g., 274, 242a, from a distributed application 212 or alternatively obtained directly from a KYC compliant public ledger 240. In response, identity trait verifier 210 performs one or more verification checks in accordance with this disclosure to ensure that the user 206, or user's wallet 206a, is registered in registry 214 and satisfies the requirements of the policy information. Upon successful validation verifier 210 grants the user an authenticated token 276 for the requested transaction. A user's wallet incorporates or embeds an authenticated token, e.g., 276, in KYC transaction 230.

When decentralized contract application validates an authenticated token for a wallet, it stores an anonymized but traceable (in accordance with this disclosure) record 244a in accordance with this disclosure that authorizes subsequent transactions requested of decentralized contract application 212 by wallet 206a in accordance with this disclosure. A wallet, e.g., 206a, may revoke its credentials from a decentralized application, 212, to prevent future transactions using a wallet, e.g., 206a, e.g., in a case where a wallet 206a may be compromised. Transactions may be tracked by an authorized authority, e.g., a government auditor with a warrant to inspect financial transactions of a user. In order to audit a user's, e.g., 206, transactions, a registry, e.g., 214 with access to log data, e.g., 210a stored by an identity trait verifier, e.g., 210 is able to privately identify transactions associated with that person, e.g., by linking a wallet to a transaction using one or more of a user's PIDs, e.g., 232. In embodiments in accordance with this disclosure, no entity holds sufficient information alone to realize the real-identity of a transaction, and only when a registry, e.g., 214, possess the log files, e.g., 210a, from an identity trait verifier, e.g., 210, can the identity of a transaction be resolved.

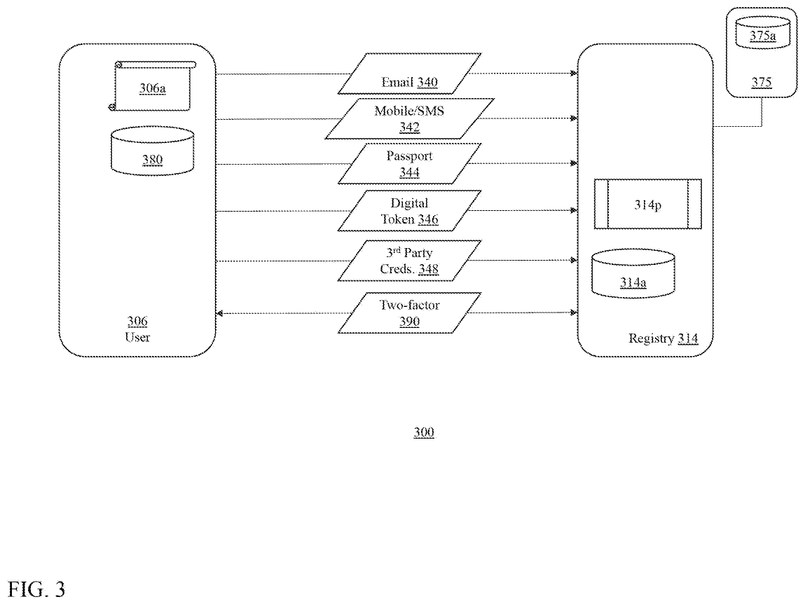

FIG. 3 illustrates a system 300 for registering a user 306 to a registry 316. In various embodiments a user 306 may communicate with registry 314 according to any suitable means. In some embodiments a user 306 may employ a digital wallet 306a to facilitate communications with a registry 314. In various embodiments a user interacts with a registry through a combination of electronic and physical interactions (e.g., in person visit, mail, or by telephone) as needed. For example, a user 306 may own a digital wallet 306a that is configured to communicate with a KYC compliant registry, e.g., registry 314. A user may use such a wallet 306a to transmit an email address 340 to the registry 314. A user may further transmit a mobile or SMS number 342, a passport 344, a registry certificate 120a, 120b, 120c, one or more digital token, e.g., 346, issued by an authority whether public or private, or one or more third party credentials 348, e.g., allowing registry 314 to independently verify various identity traits stored in a third party 375 data store 375a, e.g., a bank or credit authority. Each of these exemplary credentials, 340, 342, 344, 346, 348, is an identity trait and also an identity instrument for conveying identity traits contained within them, e.g., passport number, date of birth, social security number, address, first name, last name, dependents and/or their identity information, country of birth, country of residence, credit score, bank balance, and the like. In an example, a user 306 is able to register a passport having an embedded NFC chip that transmits identity traits stored within the passport by using a near field reader (e.g., from an iPhone or Android based device) to store the identity traits in the user's wallet 306a, and the user's wallet 306a transmits the passport information 344 received and stored from the NFC enabled passport. A registry 314 includes one or more processors 314p, configured to execute software including validation process instructions in order to validate the user's registered identity trait data. These validation processes may include, e.g., trained machine learning systems, configured queries against verifiable background information sources, e.g., 375/375a, automated reviews of social media profiles, conferences with reference individuals, and/or conferences or queries to professional organizations. In various embodiments, certain validation checks are performed automatically while others may be performed manually by, e.g., a KYC registry administrator. Upon reading this full disclosure, one will appreciate that the precise mechanisms for identity trait verification by a registry are many and varied and the particulars thereof may be performed in accordance with overall system design provided that the KYC registration process is trusted and verifiable. (While an untrustworthy KYC Registry may still literally function in accordance with this disclosure, it is preferable that a KYC Registry be accurate and trustworthy.) When a user's identity traits are registered, a user, e.g., 306, may later authenticate into the registry (e.g., to conduct transactions or to manage identity traits or other user related information). In embodiments user authentication to access a KYC Registry may require two-factor authentication 390, or other additional authentication requirements. A registry may save records of a user's verified identity traits and identity instruments within local data store 314a.

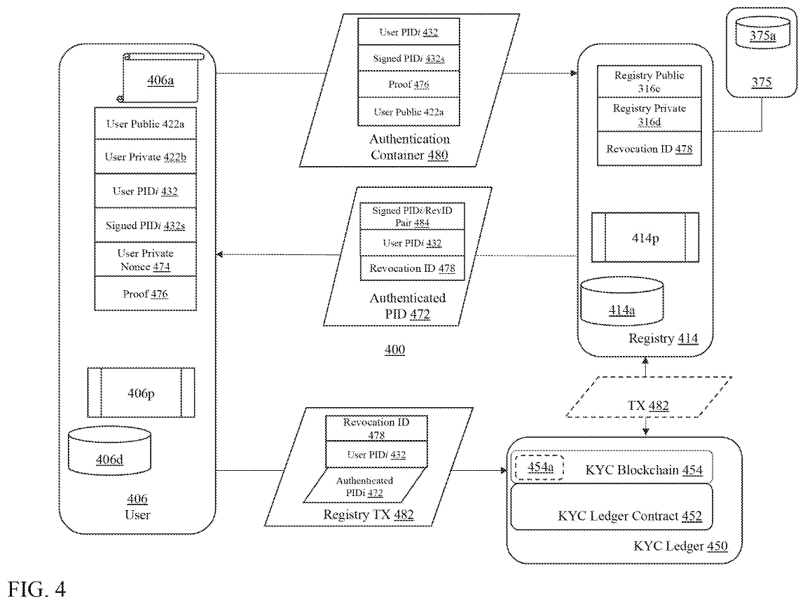

FIG. 4 illustrates a system 400 for enabling a user 406 who has registered identity traits to a registry 416 to generate and authenticate a private identification 432 in order to return an authenticated PID 472. A user may store a record of a PID 432 or of an authenticated PID 472, e.g., in a local datastore 406a, e.g., in a user's digital wallet 406a. A user 406 may have or include one or more processors 406p that execute stored instructions that carry out operations attributed to a user herein. Such instructions may be stored in a local data store 406d and loaded into memory for execution by processor 406p. Such instructions include generating a public/private key pair, such as user public key 422a and user private key 422b. These may be stored in a user's data store, e.g., 406d, or in a memory operatively coupled to processor 406p, or both. In embodiments a user public key 422a and a user private key 422b may be stored in a user's digital wallet 406a, which itself may be stored in a local data store 406d or in memory as needed. One will appreciate that a user public key and a user private key together form a cryptographic public/private key pair that satisfies a cryptographic relationship. In some preferred embodiments the cryptographic relationship is an asymmetric relationship. In some other embodiments the cryptographic relationship is a symmetric relationship.

A user may generate a public identifier (PID) 432 as a container object containing a select set of user identity traits together with a user public key 422a identity trait. In various embodiments, a user may generate separate PIDs for each network application it interacts with, such that a particular PID may be referred to as PIDi, where i is a whole number serving as an index number. A user also generates a private nonce 474. A private nonce value, e.g., 474, is a random private value unique, and ideally known only, to a user, e.g., 406. In cryptographic speaking, a nonce is short for “number used once” and it is preferable that the nonce is maintained in confidence by the user. A nonce value is generated here to provide security against brute force hacking attempts. In preferred embodiments, a private nonce is a cryptographic nonce generated using a randomization algorithm and has a suitably large enough number of random bits to reduce the possibility to near zero that one or more users repeating a previously used nonce (i.e., the chance of one or more users generating duplicate nonce values is probabilistically insignificant). In some embodiments, a cryptographic nonce is at least 128 bits. Upon reading this disclosure in full, one will appreciate that suitable cryptographically secure random generators for generating cryptographic nonce values are known.

A private nonce value allows a KYC complaint registry, e.g., 414 to later identify user 406 in combination with information held by identity trait verifier, 110, 210. Thus, a PIDi, e.g., 432, may include as an example (first name, last name, date of birth, country of residence, gender, PIDPubKeyᵢ (e.g., user public key 422a), PrivNonceᵢ). Upon reading this disclosure in full, one will appreciate that a PID may include any desirable identity traits as determined by the application or by, e.g., a contract policy for a particular application. In some embodiments, a PID includes both a user public key, e.g., 422a (having an associated user private key, e.g., 422b) and a private nonce value, e.g., 474, in addition to other identity traits.

In various exemplary embodiments, having authenticated to registry 414 using a user's wallet 406a, a user obtains an authenticated PID 472 as follows. Wallet 406a, executing software on a user's processor 406p, generates a private nonce 474, PrivNonceᵢ. Then wallet 406a generates a data container storing certain identity traits, e.g., Nameᵢ, Surnameᵢ, Birthdateᵢ, Countryᵢ, Sexᵢ, PIDPubKeyᵢ, PrivNonceᵢ. This container of information is then hashed, such that PIDᵢ=HASH(Nameᵢ, Surnameᵢ, Birthdateᵢ, Countryᵢ, Sexᵢ, PIDPubKeyᵢ422a, PrivNonceᵢ474).

In various embodiments, a personal identifier is a hash value generated by applying a cryptographic hash function to the user public key, the nonce value, and at least one identity trait. When generating a PIDᵢ as hash of selected identity traits, various hash algorithms are suitable, such as SHA256, MiMC, Poseidon, or Pedersen hash may be used. In various preferred embodiments, the HASH function used is Poseiden which we have found is particularly suitable for use in combination with the techniques disclosed herein, such that in such embodiments PIDi=POSEIDON(Nameᵢ, Surnameᵢ, Birthdateᵢ, Countryᵢ, Sexᵢ, PIDPubKeyᵢ 422a, PrivNonceᵢ 474). (One will appreciate upon reading this disclosure in full that any SNARK friendly hash function may be suitable for generating a PIDi for efficiency in generating zero knowledge proofs in accordance with this disclosure.) A user's wallet 406a then signs PIDi with a user private key 422b such that a signed PIDi 432s, or Signatureᵢ=SIGN_{PIDPrivKeyi}(PIDᵢ), where PIDi is a user private identifier 432. Thereby a signed copy of PIDi is generated. Techniques for signing information are known, but for example SIGN_{PIDPrivKeyi}(PIDᵢ) may be obtained by suitable signing means, for a non-limiting example by signing PIDi using a user's private key 422b. One will appreciate that there are many known methods of signing data, e.g,. sign(Data). In some embodiments, to sign data, e.g., a PIDi, first a hash of the data is generated and then the hashed data is signed using a user's private key. One will appreciate that in other embodiments data can be signed directly without first hashing. Upon reading this entire disclosure, one will further appreciate that many known algorithms for digitally signing information may be suitable, e.g., DSA developed by National Institute of Standards and Technology, RSA, ECDSA, EdDSA, BLS and the like. One will appreciate other suitable signing technologies are known.

User wallet 406a also generates a unique proof 476, or proofᵢ, that may be tailored to the specific requirements called for by a particular network application for which user 406 seeks to authenticate. Proof 476 is a digital proof that ensures proof of knowledge of a user's credentials (or identity traits, e.g., ID cards, certificates, passwords, emails, SIM cards, biometric identifiers) stored in wallet 406a. Proof 476 provides this proof without disclosing a user's identity or a user's private nonce 474. In embodiments, proof 476 is a zero knowledge proof that allows verification of statements without disclosing the source of such statements. For example, a prover, e.g., user 406, wants to prove to a network application, e.g., a decentralized credit facility, that the prover has more than a minimum amount of dollars stored in a bank account without revealing any additional identity traits about the prover (e.g., without disclosing the user's name, address, bank, type of bank account, contact information, or the like).

In various embodiments, a proof 476 as used herein at a minimum satisfies the following criteria: completeness, meaning that if the statement is true a proving entity can convince a verifying entity; soundness, meaning that a cheating prover cannot convince a verifier of a false statement; zero-knowledge, meaning that the interaction between a proving entity and a verifier entity only reveals required information if a statement is true and nothing else; succinct, meaning that the proof is smaller in size (e.g., how much on disk storage or transmission resource is require) than a size of a statement to be proven and a verifying entity has to do less work than the size of such a statement; non-interactive, meaning the proof is one single message from the prover entity to the verifier entity; argument, meaning the proof is only computationally sound, such that an otherwise unbounded proving entity could prove a false statement; and knowledge, meaning the prover knows a witness (w) such that there is an extractor algorithm that interacts with a prover entity to output w.

In various embodiments a proof 476 is a zero-knowledge succinct non-interactive argument of knowledge, or a ZKSNARK, plonk, a Pinnochio zero-knowledge proof, or another verifiable computation protocol. We have found through testing that ZKSNARK is a practical and sufficiently efficient zero-knowledge proof that performs well in large-scale distributed computing environments which allow for desirable scaling of identity verification applications as a base of users 106 grows. However, other zero-knowledge proofs, like plonk, may be used as desired to generate a proof, e.g., 476.

Through testing, we have also found that that when generating a proof 476 in accordance with this disclosure Poseidon is the most efficient known hashing protocol. We have found that SHA256 compression is highly inefficient and requires 448 bits of inputs and requires about 27,000 constraints. MiMC/e7r91 is substantially more efficient and achieves 256-bit security with 448 bits of input but only 730 constraints and achieves 128-bit security with 448 bits of input but only 370 constraints. Pederson Hash is also an improvement, but still has been found to have 8 times more constraints than Poseidon. More generally, we denote H(•) for the conventional strong collision resistant hashing process where.

H:{0,1}*→{0,1} [symbol] ,

where [symbol] is a fixed length of output (e.g., if H(•) is SHA-256 based, then [symbol] =256).

Having generated PIDᵢ, Signatureᵢ, and Proofᵢ in various exemplary embodiments a user wallet generates an authentication container 480 for transmitting to a registry 414. An authentication container, e.g., 480 is a container (a file, a packet, a series of packets, or other suitable data structure for transmitting information between two computer processors) suitable for transmission, e.g., via HTTPS, HTTP, or any other suitable protocol as dictated by a network environment, e.g., 198. Authentication container 480 includes PIDᵢ 432, Signatureᵢ 432s, PIDPubKeyᵢ (e.g., user public key 422a), and proof 476. Having generated authentication packet 480, a user wallet, e.g., 406a, transmits the authentication container 480 to registry 414.

Upon receiving, from a user, e.g., 406, an authentication container, e.g., 480, a registry 414 first verifies the signature, e.g., signed PIDi 432s, and verifies proof 476 using a suitable proof verification algorithm as the case may be depending on the zero knowledge proof algorithm employed (e.g., ZKSNARK, Plonk or the like). A registry 414 then generates a uniformly random revocation identifier, revocation ID 478, and then authenticates the PIDi 432 by generating an authenticated PIDi 472. In various embodiments, an authenticated PIDi 472 includes at least a signed PIDi/Revocationldentifieri pair 484 by signing a container containing PIDi and Revocationldentifieri using registry private key 416d. In various embodiments a generated authenticated PIDi 472=Sign_{RegistryPrivateKey}((PIDi, Revocationldentifieri), PIDi, Revociationldentifieri). Thereby an authenticated PIDi 472 includes a generated signed copy of the data PIDi, Revocationldentifieri, as well as unsigned copies of each of PIDi and Revocationldentifieri. Registry 414 returns authenticated PIDi 472 to a user's, e.g., 406's, digital wallet 406a. In some embodiments, as discussed above, to sign data, e.g., a PIDi and a Revocationldentifieri, first a hash of the data is generated and then the hashed data is signed using a user's private key. One will appreciate that in other embodiments data can be signed directly without first hashing. Upon reading this entire disclosure, one will further appreciate that many known algorithms for digitally signing information may be suitable, e.g., DSA developed by National Institute of Standards and Technology, RSA, ECDSA, EdDSA, BLS and the like. One will appreciate other suitable signing technologies are known.

Having obtained an authenticated PIDi 472, a user 406 may initiate a registry transaction, e.g., by utilizing wallet 406a to create a registry transaction (Tx). A registry transaction is created by generating a registry transaction container, e.g., 482, containing an authenticatedPIDi 472, PIDi 432, and Revocationldentifieri 478. User wallet 406 records a registry TX 482 as a record 454a on KYC Blockchain 454 of a KYC Ledger Contract 452 of a KYC Ledger by providing (e.g., transmitting) the registry transaction container to a registry blockchain network. The registry blockchain network (or individual computers therein) execute software that validates the authenticatedPIDi 472 using the registry's public key, and upon successful validation, the blockchain network (or individual computers therein) writes PIDi 432, and Revocationldentifieri 478 to the next block added to the blockchain. Optionally, a user wallet 406a may instead send TX 482 to Registry 414 to record on the blockchain 454. Optionally, a registry provides PIDi 432, and Revocationldentifieri 478 to a blockchain application directly without returning the pair to a user's wallet first. In various embodiments, KYC public ledger 450 is a distributed entity includes a blockchain network that updates and maintains a blockchain 454. And a record, e.g., record 454a, may be written to a KYC blockchain 454, e.g., by a wallet, e.g., wallet 406a. In various embodiments, a KYC blockchain 454 is configured to store records, e.g., 454a, that contains only stored hashes of users' credentials and records of revoked credentials. In various embodiments, a KYC blockchain 454 is configured to store records, e.g., 454a, that contains only pairs of user private identifiers and revocation identifiers. In other embodiments, a blockchain record may include additional information.

In embodiments, a user's computer system and a registry's computer system communicate via one or more computer networks or in some embodiments via a direct communication connection. Thus, a user's computer system and a registry's computer system (and, accordingly, in each case the processors therein) are communicably coupled to each other.

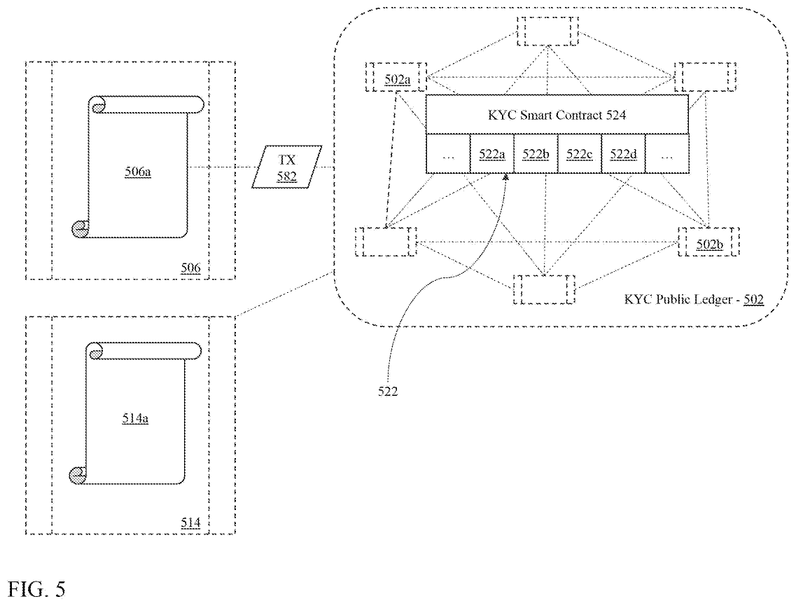

As illustrated in FIG. 5, a user 506 or other computer, e.g., a registry executing software instructions by one or more computer processors 514, interacts with a public ledger 502, which provides a blockchain 522 through the collective interactions of a network of computer processors, e.g., 502a, 502b.

In general, a distributed ledger system, e.g., 502, includes a consensus network made up of peer nodes (e.g., 502a, 502b) that enable participating entities to securely and immutably store transaction related data. Although the term “blockchain” is generally associated with the Bitcoin crypto-currency network, a blockchain as used herein generally refers more generically to a distributed ledger without reference to any particular use case (e.g., Bitcoin, Ethereum, BSC, Avalanche). A blockchain, e.g., 522, within a distributed ledger, e.g., 502, can be provided as a public blockchain network, a private blockchain network, or a consortium blockchain network. Upon reading this disclosure in full, one will appreciate that a public blockchain network is open for all entities to use the distributed ledger, and participate in the consensus process. A private blockchain network is accessible to a particular entity; e.g., a KYC Registry may maintain a private blockchain such that all transactions are performed through and by a registry processor, e.g., 514, which centrally controls read and write permissions. A consortium blockchain network is provided for a select group of entities, which control the consensus process, and includes an access control layer; e.g., a KYC registry may maintain an access control layer to the ledger 502 and provide access to the blockchain to authenticated users, e.g., 506, via the access control layer.

In various embodiments, when a user, e.g., 506, via a wallet, e.g., 506a, authenticates a set of credentials or a collection of identity traits, the user transmits a registry transaction in accordance with this disclosure, e.g., Tx 582. A smart contract 524 maintained by a consensus network of nodes (e.g., 502a, 502b) validates a user's authenticated PIDi using a public key Registry_{PubKey} of a corresponding registry, e.g., 514, which is known to consensus network nodes (e.g., 502a, 502b). Assuming a user's authenticated PIDi validates successfully, a record containing PIDi and Revocationldentifieri from Tx 582 is added to a next block to be added to a blockchain 522, and one or more network nodes, e.g., 502a, 502b, execute a consensus algorithm according to a consensus protocol (e.g., a proof-of-work protocol) to achieve agreement between the nodes for the addition of the new block, e.g., 522d, containing Tx 582 to the blockchain 522. Optionally, in some embodiments a registry 514 is configured to store a transaction to a KYC ledger 502 on behalf of a user, e.g., 506. Upon reading this full disclosure, one will appreciate that a variety of known consensus protocols are known and suitable for use to achieve agreement for adding a block, e.g., 522b, to a blockchain 522 in accordance with a policy established by a KYC Smart Contract 524. In various embodiments, a KYC Smart Contract 524 realizes an append-only list of records on a blockchain 522. In some embodiments a KYC Smart Contract 524 realizes an append-only list of records with corresponding timestamps TimestampPlDi on a blockchain 522.

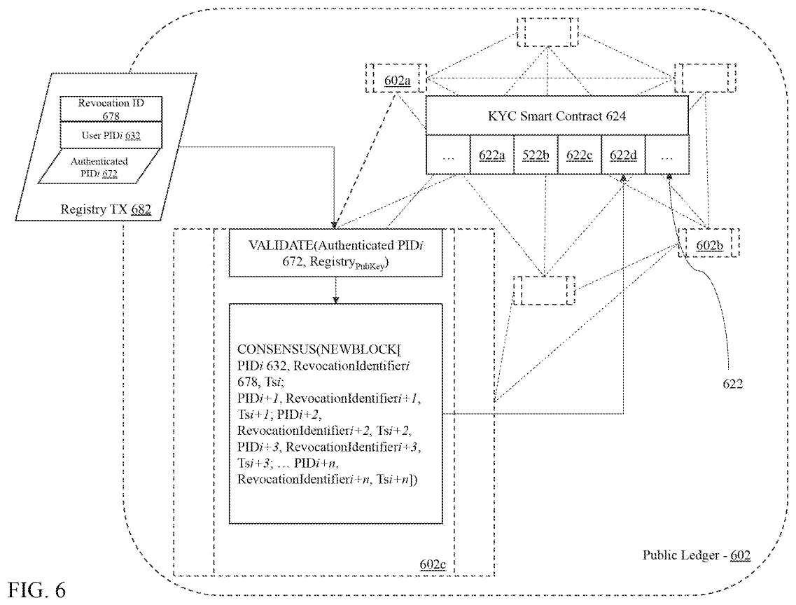

For example, as illustrated in FIG. 6, a public ledger consensus network 602 receives a registry TX 682 from a user. Registry TX 682 contains a user's authenticated PIDi 672, PIDi 632, and revocation ID 678. PIDi 632=POSEIDON({SetOfIdentityTraits}ᵢ, PIDPubKeyᵢ, PrivNonceᵢ), where PrivNonceᵢ is userᵢ's random private value, and PIDPubKeyᵢ is userᵢ's public key and authenticated PIDi 672=(Sign_{RegistryPrivateKey}(PIDi 632, Revocationldentifieri 678), PIDi 632, Revociationldentifieri 678)), where Revocationldentifieri is a revocation identifier assigned to PIDi 672 by a registry and the signature of authenticated PIDi 672 is generated using that same registry's private key. One or more processors, e.g., 602c, first validate authenticated PIDi 672, and upon successful validation, useri's PIDi 632 and Revocationldentifieri 672 are added to a next block for addition to a blockchain 622. When a next block includes sufficient, n, records a consensus network of public ledger 602, including 602a, 602b, 602c, carry out the ledger's consensus protocol in order to add the new block 622d to blockchain 622. In various embodiments, records stored on the blockchain contain as little information as necessary in order to minimize computational requirements for adding records to the blockchain. In certain embodiments a record contains only a user's PIDi, a corresponding uniform random revocation identifier, and a timestamp associated with the record. In certain embodiments a record contains only a user's PIDi and a corresponding uniform random revocation identifier.

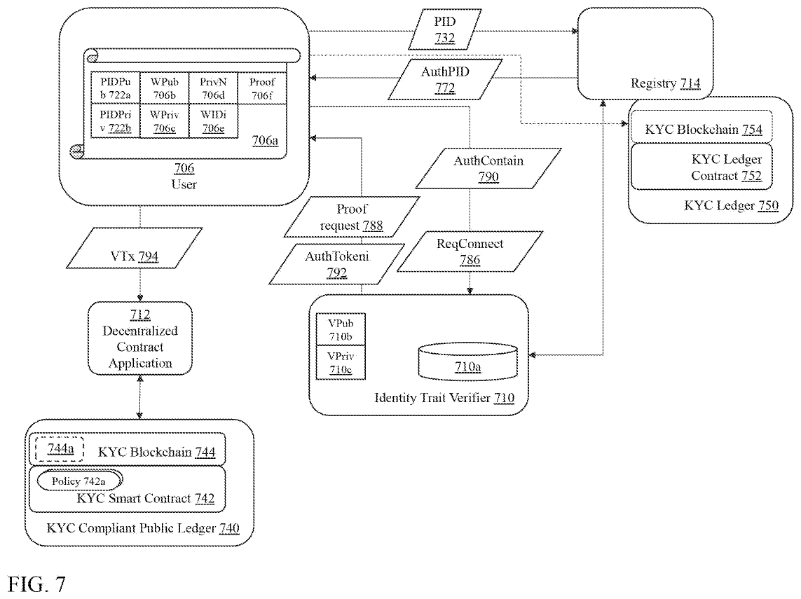

Having completed a registry transaction, in various embodiments as illustrated in FIG. 7, a user 706 has a wallet 706a that validates a user's PIDi for use with a network application 712, e.g., a decentralized network application (although one will appreciate that these processes would also work with a centralized network application), via a series of interactions between a user's wallet 706a, an identity trait verifier 710, a KYC Ledger 750, and a KYC compliant decentralized application 712 that interacts, e.g., with a KYC complaint smart contract 742 in combination with KYC blockchain 744 of a decentralized ledger 740. Validating a useri's PIDᵢ for use with a network application 712 in accordance with this disclosure is conducted in a manner that allows for the protection of userᵢ's privacy in accordance with the policies 742a of a KYC compliant smart contract 742. For example, a decentralized network application, e.g., 712, may be a Uniswap application that performs under policies that require that a user, e.g., 706, verify their country of origin and will reject transactions if a user's wallet 706a public keys are not KYC complaint or that would disclose a user's identity. In accordance with this disclosure, in such a scenario, only a user's country of origin is verified and all other identity traits of the user remain private and unknown to the application 712, the verifier 710a, the registry 714, and undisclosed on the distributed ledgers 750 and 740. As described below, the identity of user and the transaction can only be accomplished by a registry in combination with log file information stored by a verifier.

In various embodiments, a user's wallet 706a generates a public/private key pair, 706b/706c. User's wallet 706a then authenticates its WalletPubKeyᵢ706b to the decentralized application 712. Wallet 706a sends a connection request 786 to identity trait verifier 710. Connection request 786 includes WalletPubKeyᵢ706b and a reference to a desired network application, e.g., decentralized application 712, to which a user 706 desires to be validated to (e.g., a domain name DAppDomainName (e.g., Uniswap.org), a name, a reference number, or other identifying information for identifying a network application). In response, identity trait verifier returns a zero knowledge proof request 788 corresponding to a policy 742a of a desired decentralized application 712 that includes a timestampi. For example a zero knowledge proof according to application 712 may require verification of an age or country of user 706. If it not already available in wallet 706a a user obtain a PIDi 732 and requests an authenticated PIDi 772 in accordance with this disclosure.

With Timestampi, a PIDi 732, authenticated PIDi 772, a reference to application 712 (e.g., DAppDomainName), and the user's PrivNoncei 706d, the user generates a wallet ID 706e (WIDi) for user's wallet 706a for a desired application 712. In various embodiments, a wallet ID is generated such that WIDi 706e=HASH(PubCredentiali, PrivCredentiali, PIDPubKeyi 722a, PrivNoncei 706d, WalletPubKeyi 706b, DAppDomainName, TimeStamm), where HASH is a suitable has function and PubCredentiali includes (or references (e.g., names, reference numbers, indexes or the like)) a set of traits that will be disclosed to application 712, and PrivCredentiali includes (or references) a set of traits encoded in PIDi that will remain private and will not be disclosed. In some embodiments, the most efficient HASH function is Poseidon, such that WIDi 706e=POSEIDON(PubCredentiali, PrivCredentiali, PIDPubKeyi 722a, PrivNoncei 706d, WalletPubKeyi 706b, DAppDomainName, TimeStamm). Wallet 706a also generates a zero knowledge proof 706f in accordance with the application policy 742a. In particular embodiments, generating a zero knowledge proof 706f requires that user 706, via wallet 706a, prove that a preimage of PIDi 732 is consistent with WIDi where PubCredentiali, PIDPubKeyi 722a, WalletPubKeyi 706b, DAppDomainName, Timestampi will be disclosed to application 712 and PrivCredentiali and PrivNoncei 706d will remain private. In various embodiments, a zero knowledge proof 706f is generated as a ZKSNARK, but upon reading this full disclosure one will appreciate that other zero-knowledge proofs are also suitable. Wallet 706a then generates an application signature as a signed container containing PIDi 732, and WIDi 706e, signed by the wallet private key 706c. Thus, in various embodiments an application signature AppSignaturei=SIGN_{WalletPrivKeyi}(PIDi 732, WIDi 706e). Thereby a signed copy of the data PIDi 732, WIDi 706e are generated using the wallet private key. Wallet 706a then sends an authorization container 790 to an identity trait verifier 710. An authorization container in various embodiments, e.g., contains PIDi 732, WIDi 706e, PubCredentiali, Proof 706f, Signaturei. A identity trait verifier 710 receives an authorization container 790 and obtains (e.g., requests and subsequently receives) a corresponding Revocationldentifieri and LatestAccumulator from registry 714 which retrieves this information from KYC Ledger Contract 752 (one will appreciate that in certain configurations identity trait verifier 710 obtains this information directly from KYC ledger contract 752). Assuming that PIDi has not been revoked, an identity trait verifier 710 generates an authenticated token 792, e.g., authenticatedtokeni, that is signed by the identity trait verifier 710 using its private key 710c (VPriv) and returns it to wallet 706a. In various embodiments an authenticatedtokeni 792=SIGN_{VPrivKeyi}(PIDi 732, WIDi 706e). One will appreciate that an authentication token's signed information may include more than PIDi 732, WIDi 706e as desirable. One will also appreciate that in various embodiments, an authenticated token generated in connection with a specific WIDi, e.g. 706e, for verifying to a network application having a specific policy, e.g., 742a, may also be employed to authenticate with any network application that requires the same policy be satisfied in order to register the wallet.). In some embodiments, to sign data, e.g., a PIDi, and a WIDi, first a hash of the data is generated and then the hashed data is signed using a user's private key. One will appreciate that in other embodiments data can be signed directly without first hashing. Upon reading this entire disclosure, one will further appreciate that many known algorithms for digitally signing information may be suitable, e.g., DSA developed by National Institute of Standards and Technology, RSA, ECDSA, EdDSA, BLS and the like. As discussed above, other methods are known.

Having an authenticatedtokeni 792, a wallet 706a generates a verified transaction 794 (VTx) to the decentralized application 712. In various embodiments, VTx 794 includes (authenticatedtokeni 792, WIDi 706e, WalletPubKeyi 706b, DAppDomainName). One will appreciate that a verified transaction may include additional information.

Upon receiving a verified transaction, e.g., VTx 794, a complaint decentralized application will verify the transaction by validating AuthenticatedTokeni using a public key, e.g., public key 710b (VPub) of identity trait verifier 710, which is known to decentralized application 712 as a complaint application. When verified transaction 794 is verified by a decentralized application 712, application 712 stores a record of the transaction, e.g., on a KYC Complaint Public Ledger 740. In various embodiments a transaction record stored within a block 744a of KYC complaint blockchain 744 includes WIDi 706e, WalletPubKeyi 706b, DAppDomainName. Upon completion of embodiments of a protocol described in reference to FIG. 7, a decentralized application 712 is configured to grant or allow all future transactions initiated by wallet 706a using WalletPubKeyi 706b. This permission has been granted without disclosing any unnecessary identifying traits of user 706.

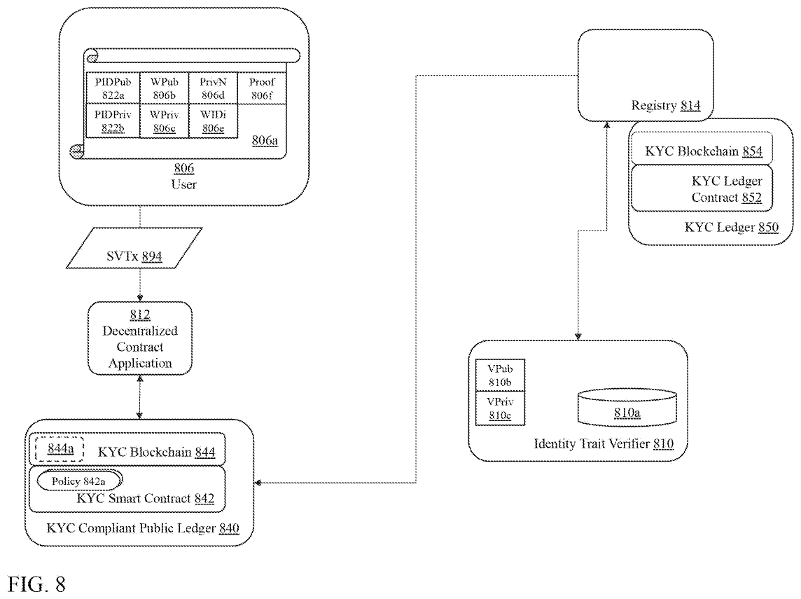

FIG. 8 illustrates a subsequent verified transaction 894 (SVTx) in accordance with this disclosure after a wallet 806a is granted future transactions using wallet public key 806b. A user 806, via wallet 806a, generates a new transaction SVTx 894 using wallet private key 806c. In embodiments, wallet 806a generates a transaction and signs it with wallet private key 806c to obtain a subsequent verified transaction 894. Wallet 806a transmits SVTx 894 to decentralized application 812. Decentralized application 812 queries public ledger 840 to determine if WalletPubKeyi 806b was already stored in a block, e.g., 844a, of blockchain 844. If so, SVTx 894 is approved by decentralized application 812. A registry 814 is able to track transactions by obtaining log data 810a from an identity trait verifier 810. Identity trait verifier 810 stores in log data 810a, in various embodiments, each PIDi, WIDi, and (WalletPubKey1, . . . , WalletPubKeyn), which allows linking between PIDi and a user's wallet public keys. Thereby a registry 814 (or another entity with the information maintained by registry 814) is able to resolve the identities and other identity traits of users of identity trait verifier 810.

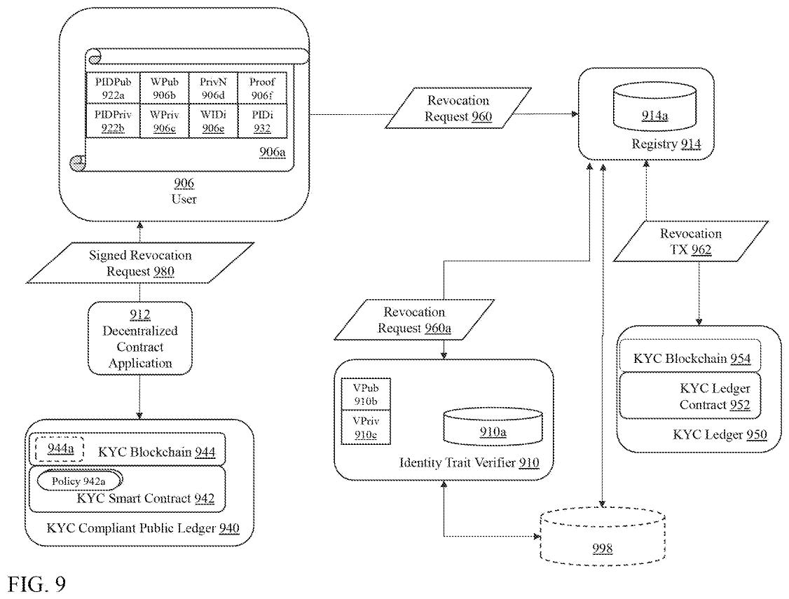

A user in accordance with this disclosure is able to revoke a user's PIDs and a user's wallet public keys. In various embodiments, a user may only revoke a PID if all wallet public keys linked to such a PID have already been revoked. For example, as illustrated in FIG. 9, a user may issue to registry 914 a revocation request 960 to request that PIDi 932 be revoked. A registry 914 sends a revocation request 960a to identification trait verifier 910. In various embodiments, a revocation request 960a includes PIDi 932. In various embodiments, identity trait verifier 914 responds with the status of any unrevoked wallet public key, e.g., 906b. In some embodiments, an identity trait verifier 914 responds only with an existence status of any unrevoked wallet, e.g., 906a, based on the status of unrevoked wallet public keys, e.g., 906b. In some embodiments, an identity trait verifier 914 will respond solely with a true/false status of whether any unrevoked wallet exists linked to a PIDi. In some preferred embodiments, a KYC Registry is unable to obtain addition information about a wallet, because an identity trait verifier is configured to prohibit sharing of wallet public keys or information about them aside from their status as revoked or unrevoked.

In various embodiments, a user 906 authenticates to registry 914 and requests a revocation of a user's private identifier. Registry 914 returns to the user a list (e.g., via a GUI) of the user's PIDs. The user then selects the PIDi to be revoked and submits a corresponding request 960. Registry 914 then queries identity trait verifier 910. If and only if identity trait verifier 910 confirms that no unrevoked wallets exist associated with PIDi, registry 914 initiates the revocation process, e.g., by executing suitable instructions for performing a revocation process from a data store 914a of registry 914. If one or more unrevoked wallets exist, registry 914 returns a rejection notice to wallet 906a.

In various embodiments, upon confirming no unrevoked wallets exist, registry 914 generates a revocation transaction 962. A revocation transaction 962 includes a revocation accumulator, e.g., LatestAccumulator, and Signaturei. LatestAccumulator may include Update(PreviousAccumulator, Revocationldentifieri) and Signaturei includes a signed (LatestAccumulator, PreviousAccumulator), e.g, =Sign_{RegistryPrivKey}(LatestAccurnulator, PreviousAccumulator), such that the pair of LatestAccumulator, PreviousAccumulator are signed with a registry private key that satisfies a cryptographic relationship with a registry public key. By signing the pair of LatestAccumulator, PreviousAccumulator using registry private key a signed copy of the pair of LatestAccumulator, PreviousAccumulator is generated. Registry then submits revocation transaction 962 to the KYC ledger contract 952 for validation. KYC ledger contract 952 validates Signaturei and updates LatestAccumulator in Signaturei. Registry 914 then sends a revocation success notice to wallet 906a. In preferred embodiments, Nguyen's dynamic accumulator is employed for the revocation process, however other witness based accumulators may be suitable. A revocation process in general performs membership witness, update and verification by a verifier. For each accumulated value there is a witness (w) such that the correctness of an accumulator can be verified through zero-knowledge proofs that require no relevant data regarding a witness to be revealed.). In some embodiments, to sign data, e.g., a LatestAccumulator, PreviousAccumulator, first a hash of the data is generated and then the hashed data is signed using a user's private key. One will appreciate that in other embodiments data can be signed directly without first hashing. Upon reading this entire disclosure, one will further appreciate that many known algorithms for digitally signing information may be suitable, e.g., DSA developed by National Institute of Standards and Technology, RSA, ECDSA, EdDSA, BLS and the like. One will appreciate other suitable signing technologies are known.

In embodiments an accumulator process is embodied in software stored in a data store that may be executed by a processor. Upon reading this full disclosure, one will appreciate that software instructions in accordance with this disclosure may perform instructions in accordance with the following algorithm:

### Accumulation Parameters.

Λ: Accumulator.
k: identifier of a signature.
W: witness to check whether k is in Λ.
1. Z=zQ where z ∈ [symbol] ₁* key of KYC registry and Q is a generator of [symbol] ₂. During the registration. Z is written to the smart contract.
2. The accumulator Λ is initially assigned with a random value in [symbol] ₁.
   Accumulator Update. Assume that we are given Λ_{old} and we would like to revoke kⱼ. In this case, the revocation process will be as follows:
1. The KYC registry computes

$${Λ}_{new} = \frac{1}{{k}_{j} + z} \cdot {Λ}_{old} .$$

2. Let

$${W}_{i}^{old} = \frac{1}{{k}_{\text{?}} + z} \cdot {Λ}^{old} .$$

$$\text{?} \text{indicates text missing or illegible when filed}$$

The KYC registry computes

$${W}_{i}^{new} = ( \frac{1}{{k}_{j} + z} ) \cdot {W}_{i}^{old} = ( \frac{1}{{k}_{j} + z} ) \cdot ( \frac{1}{{k}_{i} + z} \cdot {Λ}_{old} ) = ( ( \frac{1}{{k}_{i} + z} - \frac{1}{{k}_{j} + z} ) \cdot \frac{1}{{k}_{j} - {k}_{i}} ) \cdot {Λ}_{old} = ( \frac{1}{{k}_{j} - {k}_{i}} ) \cdot ( {W}_{i}^{old} - {Λ}_{new} ) .$$

3. The KYC registry publishes (Λ_{new}, kⱼ) by submitting in a transaction to the smart contract as

SignedRevocatin=Sign_{RegistryPrivKey}((Λ_{new},Wᵢ^{new}))

to the chain.
Witness Update by th Smart Contract. The smart (contact does the followings:
1. it first validates the signature.
2. updates the state (Λ_{new}, Wᵢ^{new}).
   Check whether any value k is revoked. The witness for a value k accumulated in Λ_{new} is

$${W}_{\text{?}}^{new} = \frac{1}{\text{?}} {Λ}_{new} .$$

$$\text{?} \text{indicates text missing or illegible when filed}$$

Note that (Wᵢ^{new}, k) can be verified through

e(Wᵢ^{new},Z+kQ) [symbol] e(Λ,Q)}.

In embodiments, when a wallet, e.g., 906a, remains unrevoked to revoke a PID a user must first revoke remaining unrevoked wallets. In embodiments, wallet 906a generates a signed revocation request 980 as SignRevj=Sign_{WalletPrivKeyi}(Revocation,WalletPubKeyj 906b) and submits it to a decentralized application 912. Decentralized application 912 validates SignRevj and updates the revocation status Revocation within SignRevj if successful.

If some embodiments, a user may revoke all wallets linked to a PID. For example, after authenticating with a registry 914 as described above, a user 906 may request revocation of a PID linked to unrevoked wallets. Registry may generate Sign_{RegistryKYC}(RevokeAllWallets, PIDi, timestampi) and sends to user's wallet 906a. Wallet 906a then may send SignRegistryKYC to an identity trait verifier 910. Identity trait verifier 910 may then obtain each WalletPubKeyi associated with PIDi, and generates RevokeSignaturei=Sign_{VPrivKey}(Revoke, {Set of all WalletPubKeyi linked to PIDi}) and transmits it to each corresponding networked application, e.g., 912. Each network application smart contract validates RevokeSignaturei using Vpub 910b and if successful the revocation status of all wallets in RevokeSignaturei are updated. By having an identity trait verifier 914 sign a revocation request, it avoids using a dynamic cryptographic accumulator for the revocation and thereby dramatically reduces blockchain processing resources needed to accomplish revocation.

In various embodiments, log data 910a of an identity trait verifier 910 is periodically (e.g., once an hour, once a day, once every 15 minutes) encrypted in a hybrid fashion to create CiphertextData=EncryptSymmetric_{K}(LogData, t) and CiphertextKey=EncryptAsymmetric_{KYCPubKey}(K), where LogData is the log data 910a to be encrypted, t is a timestamp, and K is a symmetric key encrypted by registry 914's public key and which may be used to decrypt CiphertextData. For example, EncryptSymmetric can be implemented as AES256 and EncrtypAsymmetric can be implemented as RSA-4096. In various embodiments, identity trait verifier 910 then stores CiphertextData 998a and CiphertextKey 998b to a decentralized storage 998 where registry 914 can obtain the logs on demand using its private key without communication with identity trait verifier 910. One will appreciate that many variations of secure storage of log files may be realized, including securely at identity trait verifier 910's location or in a shared storage between registry 914 and identity trait verifier 910.

In some embodiments, a registry public ledger is a blockchain ledger. A blockchain may be a data structure that includes blocks of data chained (i.e., linked) to each other. Each subsequent user private identifier may be recorded as a separate data block of the blockchain ledger or multiple user private identifiers may be recorded in a same block.

In certain embodiments, each of the data blocks of the blockchain ledger may include hashed data, e.g., a hashed record. A data block that is linked to a previous data block may include a hashing of hashed data of the previous data block. Each block may include data and metadata. Metadata may include a reference, or a pointer, to the previous block in the chain and a unique identifier associated with the previous block. The unique identifier may be an output of a hash function. In certain embodiments, some or all of the data and/or metadata may be encrypted. In other embodiments, some or all of the data and/or metadata may not be hashed or encrypted.

In some embodiments, the blockchain ledger may be implemented as a distributed ledger. The distributed ledger may include a plurality of nodes. Each of the plurality of nodes may include a separate computer system. Each node may store a synced copy of the blockchain ledger. The copies may, in certain embodiments, be synced via consensus. Consensus-based syncing may include only adding data blocks to the ledger when the nodes reach a consensus according to a consensus algorithm. The distributed ledger may use any suitable consensus algorithm such as Proof of Work, Proof of Stake, or Practical Byzantine Fault Tolerance. Consensus-based syncing may further contribute to the security and tamper-resistance of the system.

The distributed ledger may, in some embodiments, be a public, or unpermissioned, distributed ledger. A public distributed ledger may not have restriction on which system may participate in the establishing a consensus for adding to the record.

The distributed ledger may, in certain embodiments, be a private, or permissioned, distributed ledger. A private distributed ledger may have restrictions on which system may participate in the establishing a consensus for adding to the record. In some embodiments, only the KYC Registry may add records. In some embodiments, only registered users, who have registered identity trait information with the KYC Registry, may add records to the registry blockchain.

The distributed ledger may, in some embodiments, utilize a combination of private and public participation in establishing a consensus. For example, the distributed ledger may require a threshold number of private and/or public votes, or a specific predetermined combination thereof, before recording a transaction on the distributed ledger. Utilization of private entities may allow for achieving a consensus (or rejection) of a transaction faster than wholly public distributed ledgers.

Nodes of the distributed ledger may, in certain embodiments, include entities which can receive requests to read or write to a blockchain from users, from a registry, or from an identity trait verifier.

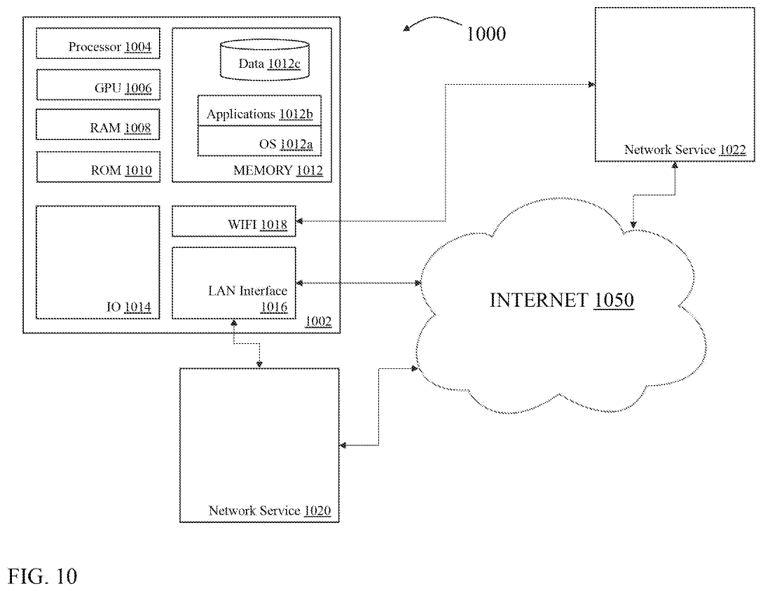

FIG. 10 shows an illustrative block diagram of system 1000 that includes computer 1002. Computer 1002 may alternatively be referred to herein as a “server” or a “computing device.” Computer 1002 may be a workstation, desktop, laptop, tablet, smart phone, or any other suitable computing device. Elements of system 1000, including computer 1002, may be used to implement various aspects of the systems and methods disclosed herein.

Computer 1002 may have a processor 1004 for controlling the operation of the device and its associated components, and may include one or more GPUs 1006, RAM 1008, ROM 1010, input/output module 1014, and a memory 1012. The processor 1004 may also execute all software running on the computer, e.g., the operating system 1012a and/or various applications 1012b, e.g., a digital wallet, a registry service, an information verifier, a network application, a blockchain network node. Other components commonly used for computers, such as EEPROM or flash memory or any other suitable components, may also be part of the computer 1002 as one will appreciate upon reading this disclosure in its entirety. In various embodiments, applications 1012b may include instructions embodied in software for carrying out one or more steps described herein or embodying one or more structures disclosed herein.

The memory 1012 may be comprised of any suitable combination of transitory and non-transitory storage technology as required by design implementation of systems and methods in accordance with this disclosure, and information may be moved between them as needed. The memory 1012 may store software including the operating system 1012a and application(s) 1012b along with any data 1012c needed for the operation of the system 1000. Memory 1012 may also store videos, text, and/or audio assistance files. The videos, text, and/or audio assistance files may also be stored in cache memory, or any other suitable memory. Alternatively, some or all of computer executable instructions (alternatively referred to as “code”) may be embodied in hardware or firmware (not shown). The computer 1002 may execute the instructions embodied by the software to perform various functions.

Input/output (“I/O”) module 1014 may include connectivity to a microphone, keyboard, touch screen, mouse, and/or stylus through which a user of computer 1002 may provide input. The input may include input relating to cursor movement. The input may relate to assembling, storing, and leveraging travel data. The input/output module may also include one or more speakers for providing audio output and a video display device for providing textual, audio, audiovisual, and/or graphical output. The input and output may be related to computer application functionality. The input and output may be related to assembling, storing, and leveraging travel data.

System 1000 may be connected to other systems via a local area network (LAN) interface 1016.

System 1000 may operate in a networked environment supporting connections to one or more network services, e.g., remote computers, such as network service 1020 and 1022. Network services 1020 and 1022 may be personal computers or servers that include many or all of the elements described above relative to system 1000. The network connections depicted in FIG. 10 include a local area network (LAN) and wide area networks (WAN), but may also include other networks. When used in a LAN networking environment, computer 1002 is connected to such a LAN through a LAN interface or adapter 1016. When used in a wireless networking environment, computer 1002 may include a wifi network adapter 1018 or other means for establishing communications over wireless. Various communication in embodiments disclosed above further communicate via a WAN such as the internet 1050 as discussed above.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit a user to retrieve web pages from a web-based server. The web-based server may transmit data to any other suitable computer system. The web-based server may also send computer-readable instructions, together with the data, to any suitable computer system. The computer-readable instructions may be to store the data in cache memory, the hard drive, secondary memory, or any other suitable memory.

Additionally, application program(s) 1012b, which may be used by computer 1002, may include computer executable instructions for invoking user functionality related to communication. Application program(s) 1012b may include computer executable instructions for invoking user functionality related performing various tasks as described herein. The various tasks may be related to assembling, storing, and leveraging identity trait information and related data and encoded data, encrypted or obfuscated, as described herein.

Computer 1002 and/or network resources 1020 and 1022 may also be devices including various other components, such as a battery, speaker, and/or antennas (not shown).

Any information described above, and any other suitable information, may be stored in a memory, e.g., 1008, 1010, or 1012. One or more of applications 1012b may include one or more algorithms that may be used to implement features of the disclosure, and/or any other suitable tasks.

The equipment described in reference to FIG. 10, one will appreciate upon reading this disclosure in its entirety, may be employed to implement various processes, devices, systems, instructions, or methods in accordance with this disclosure.

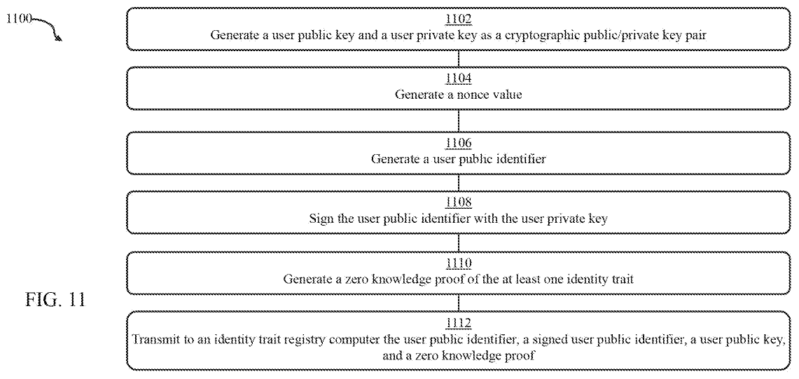

FIG. 11 illustrates a set of steps 1100 that may be carried out by a processor, e.g., processor 1004, of a computer, e.g., computer 1002 pursuant to instructions which may be loaded in memory, e.g., RAM 1008, for execution from a non-transitory memory. The steps may be part of a transaction conducted privately via a computer network. The steps work to validate information of a user by registering a user private identifier to a registry. In a first step 1102, one or more processors that are communicably coupled to a registry computer system generate a user public key and a user private key, the user public key and the user private key together forming a user cryptographic public/private key pair, e.g., 422a/422b. As such, a user public key and a user private key satisfy a cryptographic relationship that may be symmetric or asymmetric. In various embodiments, the relationship is preferably asymmetric. As used herein one will appreciate that communicably coupled is intended to mean, in the context of a computer network, that both computers are coupled to the network and capable of communicating with each other via the network. One or more computers then generate a nonce value using a cryptographic random generator, e.g., nonce 474, in a second step 1104. One or more processors in a step 1106 generate a user public identifier. In various embodiments, a user public identifier, e.g., 432, is a hash value generated by applying a cryptographic hash function to: the user public key, the nonce value, and at least one identity trait that the user has previously registered with the registry (e.g., one or more identity traits that have be registered with a registry and which may be stored in a data store 380 belonging to a user or in a digital wallet, e.g., 306a). One or more processors sign, in step 1108, the user public identifier with the user private key to obtain a signed user public identifier. In embodiments the contents of the user public key, the nonce value, and at least one identity trait that the user has previously registered with the registry are first hashed and then signed. In other embodiments, the user public key, the nonce value, and at least one identity trait are combined in any suitable manner prior to being hashed (e.g., appended, concatenated, formed into a comma delimited list) and then signed. As one will appreciate, as used herein signed is intended to be used expansively to include signing data formed of or from at least the user public key, the nonce value, and at least one identity trait. In step 1110, one or more processors generate a zero knowledge proof of the at least one identity trait. Such a proof may be a ZKSNARK proof or another suitable proof. In step 1112, one or more processors transmit to the registry computer system: the user public identifier, the signed user public identifier, the user public key, and the zero knowledge proof.

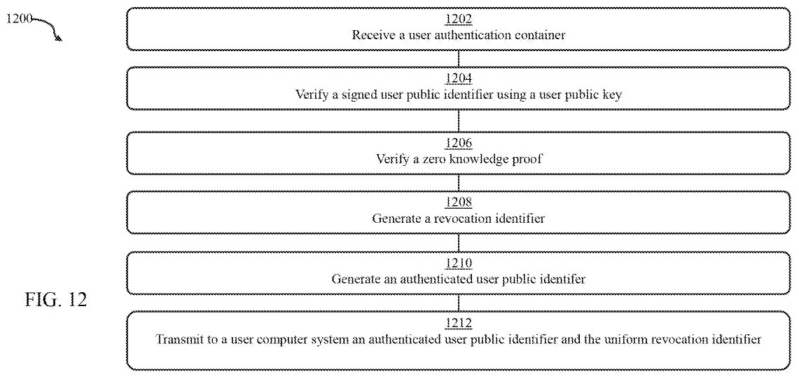

FIG. 12 illustrates a set of steps 1200 that may be carried out by a processor, e.g., processor 1004, of a computer, e.g., computer 1002 pursuant to instructions which may be loaded in memory, e.g., RAM 1008, for execution from a non-transitory memory. The steps may be part of a transaction conducted privately via a computer network. The steps work to validate information of a user by registering a user private identifier to a registry. In a first step 1202, one or more computer processors that are communicably coupled to a user computer system executing a digital wallet receive from the user computer system a user authentication container including a user private identifier, e.g., 432, a signed user public identifier, e.g., 432s, a user public key, e.g., 422a, and a zero knowledge proof of knowledge of one or more identity traits, e.g., 476. In various embodiments a proof is a ZKSNARK or other suitable proof. A user private identifier, e.g., 432 includes a hash value reflecting the application of a cryptographic hash function to one or more user identity traits that the user has previously registered with the registry, the user public key, and a user nonce value that is a statistically unique random value generated by the user computer system. A user public key is a cryptographic key satisfying a cryptographic relationship with a user private key maintained by the user computer system. A signed user public identifier is a signed copy of the user public identifier signed using the user private key, e.g., 422b; and the zero knowledge proof demonstrates proof of knowledge of the one or more user identity traits without disclosing any of the one or more user identity traits. In a step 1204, one or more computer processors verify a signed user public identifier using a user public key, e.g., 422a. In a step 1206, one or more computer processors verify the zero knowledge proof. One or more computer processors, in step 1208, generate a uniformly random revocation identifier. In step 1210, one or more computer processors generate an authenticated user public identifier. In embodiments, an authenticated user public identify is generated by by signing, with a registry private key, the user public identifier and the uniform random revocation identifier. In step 1212 one or more computer processors transmit to the user computer system an authenticated user public identifier and the uniform revocation identifier.

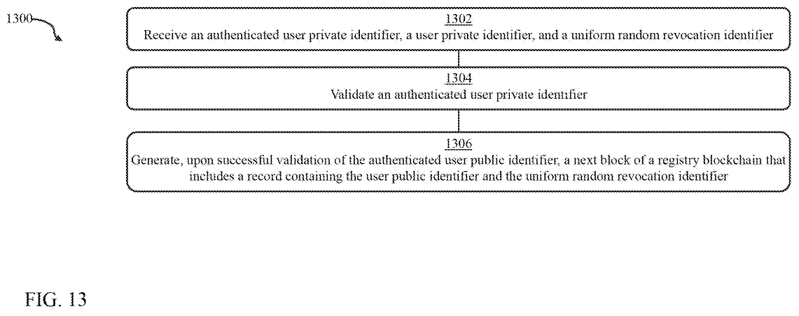

FIG. 13 illustrates a set of steps 1300 that may be carried out by a processor, e.g., processor 1004, of a computer, e.g., computer 1002 pursuant to instructions which may be loaded in memory, e.g., RAM 1008, for execution from a non-transitory memory. The steps may be part of a transaction conducted privately via a computer network. The steps work to validate information of a user by registering a user private identifier to a registry. In a step 1302 one or more computers processors coupled to the network and participating in a blockchain network receive via a network an authenticated user private identifier, a user private identifier, and a uniform random revocation identifier, e.g., 478. In various, the processors are part of a blockchain network, e.g., 502, and contain instruction to, among other things, achieve consensus regarding new blocks of a blockchain database together with other member processors within network 502. In embodiments, the blockchain network provides a KYC Ledger network application as a service to users and/or a registry. In various embodiments, a user private identifier, e.g., 432, includes a hash value reflecting the application of a cryptographic hash function to: one or more user identity traits that a user has previously registered with a registry, a user public key, and a user nonce value that is a statistically unique random value generated by a user computer system that is separate and distinct from the one or more computer processors. In various embodiments, an authenticated user public identifier, e.g., 484, includes a signed copy the user public identifier and the uniform random revocation identifier, the copying being signed with a registry private key that satisfies a cryptographic relationship with a registry public key that is stored in a memory that is communicably coupled to the one or more computer processors. In step 1304, one or more computer processors validate an authenticated user public identifier, e.g., 478, using a registry public key, e.g., 316c. In step 1306, one or more computer processors generate, upon successful validation of the authenticated user public identifier, a next block, e.g., 454a, of a registry blockchain that includes a record containing the user public identifier and the uniform random revocation identifier. Once a next block is generated (or as part of its generation) it is added to the blockchain, e.g., according to a consensus algorithm.

In various embodiments, a computer implements steps for privately conducting transactions via a computer network by validating information of a user by registering a user private identifier with a registry blockchain. The steps include storing, by the one or more computer processors, to a data store communicably coupled to the one or more computer processors, one or more blocks of a blockchain, the one or more blocks of the blockchain including at least one record containing a user private identifier that is a hash value reflecting the application of a hash function to: one or more identity traits of the user, a public key that satisfies a cryptographic relationship with a private key that is accessible in a digital wallet of the user and that is inaccessible to the one or more computer processors, and a user nonce value that is a statistically unique random value associated with the user's digital wallet, the at least one record further containing a uniform random revocation identifier corresponding to the user private identifier. As used herein, storing data to a blockchain database broadly refers to any suitable steps taken to record information to a decentralized blockchain based database. In embodiments, such storing employs a consensus algorithm by participants of the applicable blockchain network. Upon a full reading of this disclosure, one will appreciate that here are many means for storing data to a blockchain and that such storing may differ from one blockchain to another blockchain.

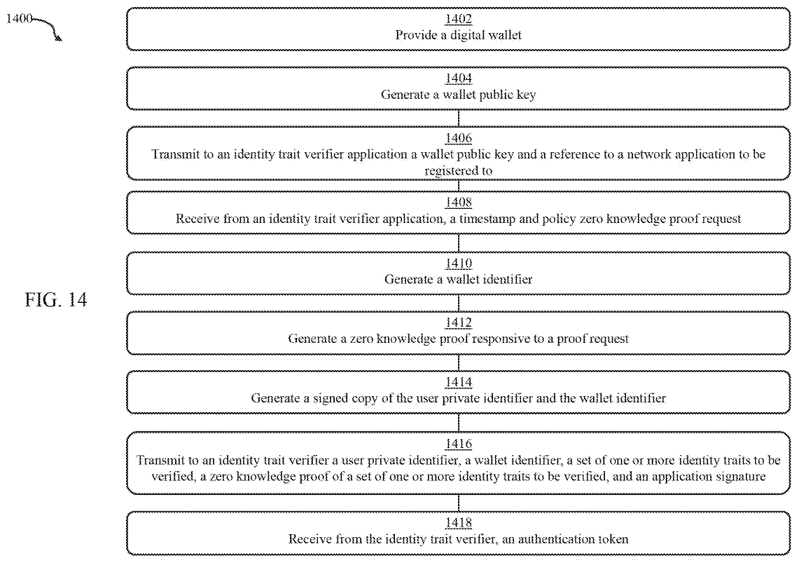

FIG. 14 illustrates a set of steps 1400 that may be carried out by a processor, e.g., processor 1004, of a computer, e.g., computer 1002 pursuant to instructions which may be loaded in memory, e.g., RAM 1008, for execution from a non-transitory memory. The steps may be part of a transaction conducted privately via a computer network. The steps work to register a digital wallet, e.g., 706a, of a user with a network application, e.g., 712, in communication with an identity trait verifier, e.g., 710, and a registry, e.g. 714, in order to authenticate transactions (a current transaction and/or future transactions) within a network application conducted by the digital wallet of the user. In a step 1402 a digital wallet storing a user public key, a user private key that satisfies a cryptographic relationship with the user public key, a user private identifier, an authenticated user private identifier, and a user private nonce value is provided in a computer memory accessible by one or more computer processors. In step 1404, one or more computer processors generate a wallet public key, e.g., 706b, and a wallet private key, e.g., 706c, that satisfies a cryptographic relationship with the wallet public key. In step 1406 one or more computer processors transmit to an identity trait verifier application a wallet public key and a reference to a network application to be registered to. In step 1408 one or more computer processors receive from an identity trait verifier application, a timestamp and policy zero knowledge proof request, e.g., 788, for verification of a set of one or more user identity traits pursuant to a policy associated with the network application. A time stamp is provided in order to ensure no replay attacks may be attempted by a nefarious actor. In step 1410 one or more computer processors generate a wallet identifier 706e. In various embodiments, a wallet identifier includes a hash of: the set of one or more identity traits to be verified, a set of one or more identity traits that will remain private, a user public key, a user private nonce value, a wallet public key, a reference to the network application, and a timestamp. In step 1412 one or more computer processors generate a zero knowledge proof, e.g., 706f, of the set of one or more identity traits to be verified. In embodiments the zero knowledge proof may be a ZKSNARK or any suitable zero knowledge proof. In step 1414 one or more computer processors generate a signed copy of the user private identifier and the wallet identifier, signed using the wallet private key to obtain an application signature. In step 1416, one or more computer processors transmit to the identity trait verifier the user private identifier, the wallet identifier, the set of one or more identity traits to be verified, the zero knowledge proof of the set of one or more identity traits to be verified, and the application signature. Ins step 1418, one or more computer processors receive from the identity trait verifier, an authentication token, e.g., 792, comprising the user private identifier and the wallet identifier each of which are signed using a verifier private key associated with a verifier public key associated with the identity trait verifier. Having received an authentication token, e.g., 792, a wallet may submit a verified transaction (VTX) with a network application.

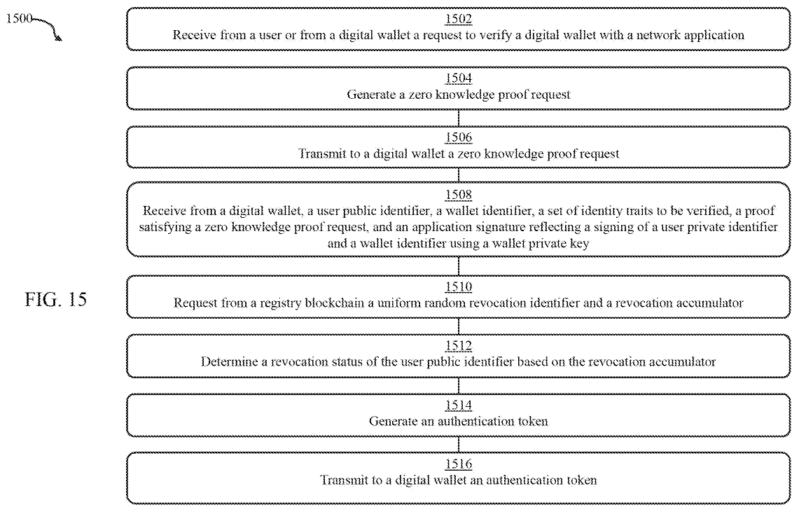

FIG. 15 illustrates a set of steps 1500 that may be carried out by a processor, e.g., processor 1004, of a computer, e.g., computer 1002 pursuant to instructions which may be loaded in memory, e.g., RAM 1008, for execution from a non-transitory memory. The steps may be part of a transaction conducted privately via a computer network. The steps work to register a digital wallet, e.g., 706a, of a user with a network application, e.g., 712, in communication with an identity trait verifier, e.g., 710, and a registry, e.g. 714, in order to authenticate transactions (a current transaction and/or future transactions) within a network application conducted by the digital wallet of the user. In step 1502, one or more computer processors that are network reachable by a user computer system executing a digital wallet, receives from the user computer system, a request, e.g., 786, to verify a digital wallet with a network application. In various embodiments a request including a reference to the network application and a wallet public key, e.g., 706b, that satisfies a cryptographic relationship with a wallet private key, e.g., 706c, stored, e.g., by a digital wallet 706a. The digital wallet is inaccessible to the one or more computer processors. In step 1504 one or more computer processors generate a zero knowledge proof request. In various embodiments, a zero knowledge proof request, e.g., 788, includes a timestamp associated with the request and a set of identity traits to be verified in order to satisfy a policy of the network application. In various embodiments, a verifier, e.g., 710a has knowledge of policies for compliant network applications. In various embodiments, a verifier, e.g., 710a is communicably coupled to a compliant network application and upon receipt of a connection request with reference to the network application, a verifier may request a policy to verify. In step 1506 one or more computers transmit to the digital wallet a zero knowledge proof request. In step 1508 one or more computers receive from a digital wallet, a user public identifier associated with the user of the wallet, a wallet identifier that uniquely identifies the digital wallet with the network application, a set of identity traits to be verified (responsive to the policy), a proof satisfying the zero knowledge proof request, and an application signature generated by a digital wallet and reflecting a signing of a user private identifier and a wallet identifier using a wallet private key. In step 1510 one or more computer processors request from a registry blockchain, e.g., 754, a uniform random revocation identifier associated with the user public identifier and a revocation accumulator, which are then received. In step 1512, one or more computer processors determine a revocation status of the user public identifier based on the revocation accumulator. In step 1514, one or more computer processors generate an authentication token including the user private identifier and the wallet identifier each of which are signed using a verifier private key satisfying a cryptographic relationship with a verifier public key associated with the identity trait verifier. In step 1516 one or more processors transmit to the digital wallet an authentication token, e.g., 792, whereby the digital wallet may verify itself to the network application, e.g., 712, without disclosing additional identity traits to the network application, the registry, or the identify trait verifier.

Embodiments in accordance with this disclosure may be operational with numerous other general purpose or special purpose computing system environments or configurations. Examples of well-known computing systems, environments, and/or configurations that may be suitable for use with embodiments in accordance with this disclosure include, but are not limited to, personal computers, server computers, hand-held or laptop devices, tablets, mobile phones, smart phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

Embodiments in accordance with this disclosure may be described in the general context of computer-executable instructions, such as program modules, being executed by a computer. Generally, program modules include routines, programs, objects, components, data structures, etc., that perform particular tasks or implement particular abstract data types. Embodiments in accordance with this disclosure may also be practiced in distributed computing environments where tasks are performed by remote processing devices that are linked through a communications network. In a distributed computing environment, program modules may be located in both local and remote computer storage media including memory storage devices.

The system, apparatus, module, or units illustrated in the previous implementations can be implemented by using a computer chip, or can be implemented by using a product having a certain function by virtue of its configuration or instructions. A typical implementation device, e.g., for implementing a digital wallet and the functions attributed thereto herein, is a computer, and the computer can be a personal computer, a laptop computer, a cellular phone, a camera phone, a smartphone, a personal digital assistant, an email receiving and sending device, a game console, a tablet computer, a wearable device, or any combination of these devices. A typical implementation device, e.g., for implementing the network applications and blockchain processing herein, is a computer, and the computer can be a personal computer, a server, a server operatively coupled with one or more GPUs, or a laptop computer. While a cellular phone, a camera phone, a smartphone, a personal digital assistant, an email receiving and sending device, a game console, a tablet computer, a wearable device, or any combination of these devices may perform these features as well, user demands may require more robust processing capabilities to enable desirable levels of service.

In a typical configuration, a computer includes one or more processors (CPU), an input/output interface, a network interface, and a memory. A computer may include one or more GPUs or special processing devices for performing blockchain processing.

The memory may include a non-persistent memory, a random access memory (RAM), a non-volatile memory, and/or another form in a computer readable medium, for example, a read-only memory (ROM) or a flash memory (flash RAM). The memory is an example of the computer readable medium.

The computer readable medium includes persistent, non-persistent, movable, and unmovable media that can store information by using any method or technology. The information can be a computer readable instruction, a data structure, a program module, or other data. Examples of a computer storage medium include but are not limited to a phase change random access memory (PRAM), a static RAM (SRAM), a dynamic RAM (DRAM), a RAM of another type, a read-only memory (ROM), an electrically erasable programmable ROM (EEPROM), a flash memory or another memory technology, a compact disc ROM (CD-ROM), a digital versatile disc (DVD) or another optical storage, a cassette tape, a magnetic disk storage, a quantum memory, a storage medium based on grapheme, another magnetic storage device, or any other non-transmission medium. The computer storage medium can be used to store information that can be accessed by the computing device. Based on the definition in the present specification, the computer readable medium does not include transitory computer-readable media (transitory media), for example, a modulated data signal and carrier.

It is worthwhile to further note that, the terms “include”, “contain”, or their any other variants are intended to cover a non-exclusive inclusion, so a process, a method, a product or a device that includes a list of elements not only includes those elements but also includes other elements which are not expressly listed, or further includes elements inherent to such process, method, product or device. Without more constraints, an element preceded by “includes a . . . ” does not preclude the existence of additional identical elements in the process, method, product or device that includes the element.

Various implementations of the present specification are described above. Other implementations fall within the scope of the appended claims. In some situations, the actions or steps described in the claims can be performed in an order different from the order in the implementations and the desired results can still be achieved. In addition, the process depicted in the accompanying drawings does not necessarily need a particular execution order to achieve the desired results. In some implementations, multi-tasking and concurrent processing is feasible or can be advantageous.

Terms used in one or more implementations of the present specification are merely used to describe specific implementations, and are not intended to limit the one or more implementations of the present specification. The terms “a” and “the” of singular forms used in one or more implementations of the present specification and the appended claims are also intended to include plural forms, unless otherwise specified in the context clearly. It should also be understood that, the term “and/or” used here indicates and includes any or all possible combinations of one or more associated listed items. Unless explicitly stated herein to the contrary, the terms for example or e.g., mean: for example without limitation. Unless explicitly stated herein to the contrary, the terms in embodiments, in various embodiments, and in some embodiments mean: in one or more but not necessarily all embodiments.

It should be understood that although terms “first”, “second”, “third”, etc. can be used in one or more implementations of the present specification to describe various types of information, the information is not limited to these terms. These terms are only used to differentiate between information of the same type. For example, without departing from the scope of one or more implementations of the present specification, first information can also be referred to as second information, and similarly, the second information can be referred to as the first information. Depending on the context, for example, the word “if” used here can be explained as “while”, “when”, or “in response to determining”.

The previous descriptions are only example implementations of one or more implementations of the present specification, but are not intended to limit the one or more implementations of the present specification. Any modification, equivalent replacement, improvement, etc. made without departing from the spirit and principle of the one or more implementations of the present specification shall fall within the protection scope of the one or more implementations of the present specification.

We claim:

1. A computer implemented method of privately conducting transactions via a computer network by validating information of a user by registering a user private identifier to a registry, the computer implemented method comprising:
generating, by one or more processors that are communicably coupled to a registry computer system, a user public key and a user private key, the user public key and the user private key together forming a user cryptographic public/private key pair;
generating, by one or more processors, a nonce value using a cryptographic random generator;
generating, by one or more processors, the user public identifier, wherein the user public identifier is a hash value generated by applying a cryptographic hash function to: the user public key, the nonce value, and at least one identity trait that the user has previously registered with the registry;
signing, by one or more processors, the user public identifier with the user private key to obtain a signed user public identifier;
generating, by one or more processors, a zero knowledge proof of the at least one identity trait; and
transmitting, by the one or more processors, to the registry computer system: the user public identifier, the signed user public identifier, the user public key, and the zero knowledge proof.

2. The computer implemented method of claim 1, further comprising:
receiving, by the one or more processors following the transmitting step, from the registry computer system, the user private identifier, a revocation identifier, and an authenticated user private identifier that includes a signed copy of the user private identifier and the revocation identifier, the signed copy being signed using a registry private key that is part of a registry cryptographic public/private key pair; and
transmitting, to a registry blockchain network, the authenticated user private identifier, the user private identifier, and the revocation identifier.

3. The computer implemented method of claim 1, further comprising storing, by the one or more processors, the authenticated private identifier within a cryptographic digital wallet.

4. The computer implemented method of claim 1, wherein the at least one identity trait is one of a first name, a last name, a date of birth, a country, an address, a bank account number, an account balance, a credit limit, a credit check result, a social security number, a passport number, a sex, or a phone number.

5. The computer implemented method of claim 1, wherein the cryptographic hash function is one of SHA256, MiMC, Poseidon, or Pedersen.

6. The computer implemented method of claim 1, further comprising: storing, by the computer system, the user private key and the user public key in a cryptographic digital wallet.

7. The computer implemented method of claim 1, wherein the registry computer system includes a registry computer processor and registry memory storing instructions for reading and writing to a registry blockchain, the registry computer system being communicably coupled to a registry blockchain network, and the registry blockchain comprising a ledger of a plurality of users private identifiers in each case paired with a respective unique revocation identifier.

8. A computer implemented method of privately conducting transactions via a computer network by validating information of a user by registering a user private identifier with a registry, the computer implemented method comprising:
receiving, by one or more computer processors that are communicably coupled to a user computer system executing a digital wallet, from the user computer system, a user authentication container including a user private identifier, a signed user public identifier, a user public key, and a zero knowledge proof, wherein:
the user private identifier includes a hash value reflecting the application of a cryptographic hash function to one or more user identity traits that the user has previously registered with the registry, the user public key, and a user nonce value that is a statistically unique random value generated by the user computer system;
the user public key is a cryptographic key satisfying a cryptographic relationship with a user private key maintained by the user computer system;
the signed user public identifier is a signed copy of the user public identifier signed using the user private key; and
the zero knowledge proof demonstrates proof of knowledge of the one or more user identity traits without disclosing any of the one or more user identity traits; and
verifying, by the one or more computer processors, the signed user public identifier using the user public key;
verifying, by the one or more computer processors, the zero knowledge proof;
generating, by the one or more computer processors, a uniformly random revocation identifier;
generating, by the one or more computer processors, an authenticated user public identifier by signing, with a registry private key, the user public identifier and the uniform random revocation identifier; and
transmitting, by the one or more computer processors, to the user computer system, the authenticated user public identifier and the uniform revocation identifier.

9. The computer implemented method of claim 8, further comprising providing, to a registry blockchain network, the authenticated user public identifier, the user public identifier, and the uniform random revocation identifier, wherein the registry blockchain network validates the authenticated user public identifier using a registry public key that satisfies a cryptographic relationship with the registry private key and writes the user public identifier and the uniform random revocation identifier to the next block of a registry blockchain.

10. A computer implemented method of privately conducting transactions via a computer network by validating information of a user by registering a user private identifier with a registry, the computer implemented method comprising:
receiving, via a network, by one or more computers processors coupled to the network and participating in a blockchain network, an authenticated user private identifier, a user private identifier, and a uniform random revocation identifier, wherein:
the user private identifier includes a hash value reflecting the application of a cryptographic hash function to: one or more user identity traits that a user has previously registered with a registry, a user public key, and a user nonce value that is a statistically unique random value generated by a user computer system that is separate and distinct from the one or more computer processors;
the authenticated user public identifier is an signed copy the user public identifier and the uniform random revocation identifier, the copying being signed with a registry private key that satisfies a cryptographic relationship with a registry public key that is stored in a memory that is communicably coupled to the one or more computer processors; and
validating, by the one or more computer processors, the authenticated user public identifier using the registry public key; and
generating, by the one or more computer processors, upon successful validation of the authenticated user public identifier, a next block of a registry blockchain that includes a record containing the user public identifier and the uniform random revocation identifier.

11. The computer implemented method of claim 10, further comprising executing, by the one or more computer processors, a consensus algorithm to achieve agreement between a plurality of blockchain network computers for the addition of the next block to the registry blockchain.

12. The computer implemented method of claim 10, wherein the record further includes a timestamp corresponding to either (i) when the record added to the blockchain or (ii) when the one or more processors receive the authenticated user private identifier.

13. The computer implemented method of claim 10, wherein the blockchain network is a public blockchain network, a private blockchain network, or a hybrid blockchain network.

14. The computer implemented method of claim 10, wherein the blockchain network is a public blockchain network and in the receiving step the one or more computers processors receive the authenticated user private identifier, the user private identifier, and the uniform random revocation identifier from a user's digital wallet application.

15. The computer implemented method of claim 10, wherein the blockchain network is a private blockchain network providing access to a private blockchain accessible by the registry.

16. A computer implemented method of privately conducting transactions via a computer network by validating information of a user by registering a user private identifier with a registry blockchain, the computer implemented method comprising: storing, by the one or more computer processors, to a data store communicably coupled to the one or more computer processors, one or more blocks of a blockchain, the one or more blocks of the blockchain including at least one record containing a user private identifier that is a hash value reflecting the application of a hash function to: one or more identity traits of the user, a public key that satisfies a cryptographic relationship with a private key that is accessible in a digital wallet of the user and that is inaccessible to the one or more computer processors, and a user nonce value that is a statistically unique random value associated with the user's digital wallet, the at least one record further containing a uniform random revocation identifier corresponding to the user private identifier.

17. The computer implemented method of claim 16, wherein the record consists of the user private identifier, the corresponding uniform random revocation identifier, and a timestamp associated with the record.

18. The computer implemented method of claim 16, wherein the record consists of the user private identifier and the corresponding uniform random revocation identifier.

19. A computer implemented method of privately conducting transactions via a computer network by registering a digital wallet of a user with a network application in communication with an identity trait verifier and a registry, the computer implemented method comprising:
providing, in a computer memory accessible by one or more computer processors, a digital wallet storing a user public key, a user private key that satisfies a cryptographic relationship with the user public key, a user private identifier, an authenticated user private identifier, and a user private nonce value;
generating, by the one or more computer processors, a wallet public key and a wallet private key that satisfies a cryptographic relationship with the wallet public key;
transmitting, by the one or more computer processors, to an identity trait verifier application, the wallet public key and a reference to the network application;
receiving, by the one or more computer processors, from the identity trait verifier application, a timestamp and policy zero knowledge proof request for verification of a set of one or more user identity traits pursuant to a policy associated with the network application;
generating, by the one or more computer processors, a wallet identifier including a hash of: the set of one or more identity traits to be verified, a set of one or more identity traits that will remain private, the user public key, the user private nonce value, the wallet public key, the reference to the network application, and the timestamp;
generating, by the one or more processors, a zero knowledge proof of the set of one or more identity traits to be verified;
generating, by the one or more processors, a signed copy of the user private identifier and the wallet identifier signed using the wallet private key to obtain an application signature;
transmitting, by the one or more processors, to the identity trait verifier, the user private identifier, the wallet identifier, the set of one or more identity traits to be verified, the zero knowledge proof of the set of one or more identity traits to be verified, and the application signature; and
receiving, by the one or more processors, from the identity trait verifier, an authentication token comprising the user private identifier and the wallet identifier each of which are signed using a verifier private key associated with a verifier public key associated with the identity trait verifier.

20. The computer implemented method of claim 19, further comprising generating, by the one or more processors, a verification transaction including the authentication token, the wallet identifier, the wallet public key, and the reference to the network application and transmitting the verification transaction to the network application.

21. The computer implemented method of claim 19, wherein the network application is a decentralized application that reads and writes to an application blockchain, and upon receipt of a verification transaction, the network application causes the wallet identifier, the wallet public key, and the reference to the network application to be stored in a verification record on the application blockchain, wherein none of the information stored on the application blockchain includes identifying information of the user.

22. The computer implemented method of claim 19, wherein the user private nonce value is never disclosed to the network application, the registry, or the identity trait verifier.

23. The computer implemented method of claim 19, wherein the policy zero knowledge proof request is a request for a zero knowledge proof verifying one or more identity traits of a user.

24. The computer implemented method of claim 19, wherein a hash function for generating the hash included by the wallet identifier is Poseidon.

25. The computer implemented method of claim 19, wherein the set of one or more identity traits to be verified includes references to one or more traits that must be verified to satisfy the policy, and the set of one or more identity traits that will remain private includes references to one or more traits that need not be verified to satisfy the policy.

26. A computer implemented method of privately conducting transactions via a computer network by registering a digital wallet of a user with a network application in communication with an identity trait verifier and a registry, the computer implemented method comprising:
receiving, by one or more computer processors that are network reachable by a user computer system executing the digital wallet, from the user computer system, a request to verify the digital wallet with the network application, the request including a reference to the network application and a wallet public key that satisfies a cryptographic relationship with a wallet private key stored by the digital wallet and that is inaccessible to the one or more computer processors;
generating, by the one or more computer processors, a zero knowledge proof request including a timestamp associated with the request and a set of identity traits to be verified in order to satisfy a policy of the network application;
transmitting, by the one or more computer processors, to the digital wallet, the zero knowledge proof request;
receiving, by the one or more computer processors, from the digital wallet, a user public identifier associated with the user of the wallet, a wallet identifier that uniquely identifies the digital wallet with the network application, the set of identity traits to be verified, a proof satisfying the zero knowledge proof request, and an application signature generated by the digital wallet and reflecting signing of the user private identifier and the wallet identifier using the wallet private key; and
requesting, by the one or more computer processors, from a registry blockchain, a uniform random revocation identifier associated with the user public identifier and a revocation accumulator;
determining, by the one or more computer processors, a revocation status of the user public identifier based on the revocation accumulator;
generating, by the one or more computer processors, an authentication token including the user private identifier and the wallet identifier each of which are signed using a verifier private key satisfying a cryptographic relationship with a verifier public key associated with the identity trait verifier; and
transmitting, by the one or more computer processors, to the digital wallet, the authentication token, whereby the digital wallet may verify itself to the network application without disclosing additional identity traits to the network application, the registry, or the identify trait verifier.

27. The computer implemented method of claim 26, wherein the proof is a ZKSNARK proof.
